(19) United States
(12) Patent Application Publication
(10) Pub. No.: US 2026/0184069 A1
(43) Pub. Date: Jul. 2, 2026

(54) LIQUID EJECTING APPARATUS AND HEAD UNIT

(71) Applicant: SEIKO EPSON CORPORATION, Tokyo (JP)

(72) Inventor: Toshimichi YAMADA, Chino (JP)

(21) Appl. No.: 19/433,139

(22) Filed: Dec. 26, 2025

(30) Foreign Application Priority Data
Dec. 27, 2024 (JP) 2024-231595

(51) Int. Cl. B41J 2/045

(52) U.S. Cl. CPC B41J 2/0451; B41J 2/04551; B41J 2/04581; B41J 2/04588

(57) ABSTRACT

A liquid ejecting apparatus includes an ejection section that ejects liquid to the medium, a detection circuit that acquires a vibration signal corresponding to residual vibration generated in the ejection section and outputs a detection signal corresponding to the vibration signal, a first conversion circuit that outputs a comparison result signal corresponding to a comparison result between a voltage value of the detection signal and a reference voltage value, a second conversion circuit that outputs a detection voltage signal obtained by converting the detection signal into a digital signal, and a determination circuit that determines a state of the ejection section, and the determination circuit includes a first determination mode in which the state of the ejection section is determined according to the comparison result signal, and a second determination mode in which the state of the ejection section is determined according to the detection voltage signal.

The present application is based on, and claims priority from JP Application Serial Number 2024-231595, filed Dec. 27, 2024, the disclosure of which is hereby incorporated by reference herein in its entirety.

### BACKGROUND

### 1. Technical Field

The present disclosure relates to a liquid ejecting apparatus and a head unit.

### 2. Related Art

As disclosed in JP-A-2017-149077, in a liquid ejecting apparatus that forms an image at a medium by ejecting liquid from an ejection section, a technique for determining a state of the ejection section based on residual vibration generated in the ejection section is known.

However, in the technique described in JP-A-2017-149077, there is room for improvement from a viewpoint of both improving a determination accuracy of the state of the ejection section and shortening an inspection time of the state of the ejection section.

### SUMMARY

According to an aspect of the present disclosure, there is provided a liquid ejecting apparatus including a transport section that transports a medium, an ejection section that ejects liquid to the medium, a residual vibration detection circuit that acquires a residual vibration signal corresponding to residual vibration generated in the ejection section and outputs a residual vibration detection signal corresponding to the residual vibration signal, a first conversion circuit that includes a comparison circuit and outputs a comparison result signal in which a logic level changes according to a comparison result between a voltage value of the residual vibration detection signal and a reference voltage value, a second conversion circuit that includes an A/D conversion circuit and outputs a detection voltage signal obtained by converting the residual vibration detection signal into a digital signal, and a determination circuit that determines a state of the ejection section, in which the determination circuit includes a first determination mode in which the state of the ejection section is determined according to the comparison result signal, and a second determination mode in which the state of the ejection section is determined according to the detection voltage signal.

According to another aspect of the present disclosure, there is provided a head unit including an ejection section that ejects liquid to a medium, a residual vibration detection circuit that acquires a residual vibration signal corresponding to residual vibration generated in the ejection section and outputs a residual vibration detection signal corresponding to the residual vibration signal, a first conversion circuit that includes a comparison circuit and outputs a comparison result signal in which a logic level changes according to a comparison result between a voltage value of the residual vibration detection signal and a reference voltage value, a second conversion circuit that includes an A/D conversion circuit and outputs a detection voltage signal obtained by converting the residual vibration detection signal into a digital signal, and a determination circuit that determines a state of the ejection section, in which the determination circuit includes a first determination mode in which the state of the ejection section is determined according to the comparison result signal, and a second determination mode in which the state of the ejection section is determined according to the detection voltage signal.

### BRIEF DESCRIPTION OF THE DRAWINGS

FIG. 1 is a diagram illustrating a schematic configuration of a liquid ejecting apparatus.

FIG. 2 is a diagram illustrating a schematic configuration of an ejection unit.

FIG. 3 is a diagram illustrating an example of a signal waveform of a drive signal.

FIG. 4 is a diagram illustrating an example of a functional configuration of a drive signal selection circuit.

FIG. 5 is a diagram illustrating an example of the functional configuration of a switching circuit.

FIG. 6 is a diagram illustrating an example of decoding contents in a decoder.

FIG. 7 is a diagram illustrating a configuration of a selection circuit.

FIG. 8 is a diagram illustrating an example of an operation of the switching circuit.

FIG. 9 is a diagram illustrating an example of a configuration of a waveform shaping circuit.

FIG. 10 is an exploded perspective view of a print head.

FIG. 11 is a cross-sectional view taken along line XI-XI in FIG. 10.

FIG. 12 is a diagram illustrating an example of a residual vibration signal.

FIG. 13 is a diagram illustrating an example of a calculation model of simple harmonic motion assuming residual vibration.

FIG. 14 is a diagram illustrating a configuration of a residual vibration acquisition circuit.

FIG. 15 is a diagram for describing an operation of an analog acquisition circuit.

FIG. 16 is a diagram for describing an example of acquisition processing in which a digital acquisition circuit acquires an acquisition residual vibration signal.

FIG. 17 is a diagram for describing an example of determination processing of determining a state of an ejection section based on information acquired in an acquisition operation.

FIG. 18 is a diagram for describing a method of a state determination of the ejection section.

### DESCRIPTION OF EMBODIMENTS

Hereinafter, preferred embodiments of the present disclosure will be described with reference to the drawings. The drawings to be used are for convenience of description. In addition, embodiments to be described below do not inappropriately limit the contents of the present disclosure described in the claims. Moreover, not all of the configurations to be described below are necessarily essential requirements of the present disclosure.

### 1. Configuration of Liquid Ejecting Apparatus

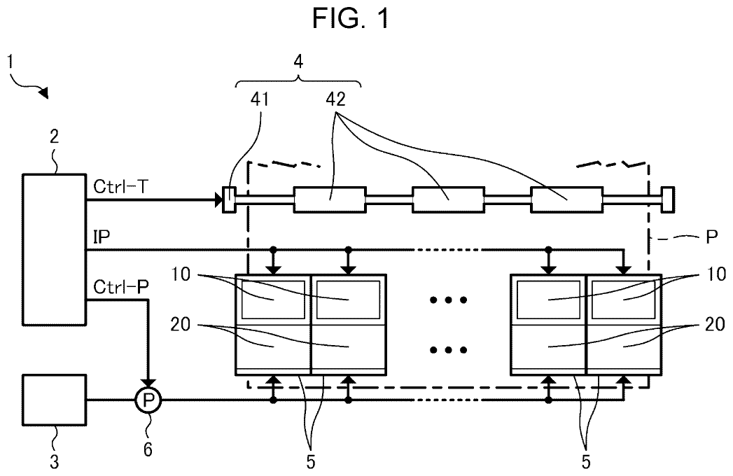

FIG. 1 is a diagram illustrating a schematic configuration of a liquid ejecting apparatus 1. As illustrated in FIG. 1, the liquid ejecting apparatus 1 is a so-called line-type ink jet printer that forms a desired image on a medium P transported by a transport unit 4 by ejecting ink, which is an example of liquid, at the medium P at a desired timing. The liquid ejecting apparatus 1 is not limited to the line-type ink jet printer, and may be a serial-type ink jet printer. Further, the liquid ejecting apparatus 1 is not limited to an ink jet printer, and may be a coloring material ejecting apparatus used for manufacturing a color filter for a liquid crystal display or the like, an electrode material ejecting apparatus used for forming an electrode for an organic EL display, a field emission display (FED), or the like, a bioorganic substance ejecting apparatus used for manufacturing a biochip, a three-dimensional fabrication apparatus, a textile printing apparatus, and the like. Here, in the following description, a direction in which the medium P is transported may be referred to as a transport direction, and a width direction of the medium P to be transported may be referred to as a main scanning direction.

As illustrated in FIG. 1, the liquid ejecting apparatus 1 includes a control unit 2, a liquid container 3, a transport unit 4, a plurality of ejection units 5, and a circulation unit 6.

The control unit 2 includes a processing circuit such as a central processing unit (CPU) and a field programmable gate array (FPGA), and a storage circuit such as a semiconductor memory. The control unit 2 outputs a signal for controlling each element of the liquid ejecting apparatus 1 based on image data supplied from an external device such as a host computer (not illustrated) provided outside the liquid ejecting apparatus 1.

The ink as an example of the liquid supplied to the ejection unit 5 is stored in the liquid container 3. Specifically, the liquid container 3 stores ink of a plurality of colors to be ejected to the medium P, such as black, cyan, magenta, yellow, red, and gray. As the liquid container 3, an ink cartridge, a bag-shaped ink pack formed of a flexible film, an ink tank which can be replenished with ink, and the like can be used.

The circulation unit 6 supplies the ink stored in the liquid container 3 to the ejection unit 5 based on a control signal Ctrl-P output by the control unit 2. Further, the circulation unit 6 collects ink discharged from the ejection unit 5 based on the control signal Ctrl-P output by the control unit 2. That is, the circulation unit 6 causes the ink to recirculate in the liquid ejecting apparatus 1. The circulation unit 6 can be configured to include, for example, a pump that generates a flow of ink in the liquid ejecting apparatus 1.

The transport unit 4 includes a transport motor 41 and a transport roller 42. A transport control signal Ctrl-T output by the control unit 2 is input to the transport unit 4. Then, the transport motor 41 is driven based on the transport control signal Ctrl-T, and the transport roller 42 rotates as the transport motor 41 is driven. With the rotation of the transport roller 42, the medium P is transported along the transport direction. That is, the liquid ejecting apparatus 1 includes the transport unit 4 that transports the medium P.

Each of the plurality of ejection units 5 includes a drive module 10 and an ejection module 20. Corresponding image information signal IP output by the control unit 2 is input to each of the plurality of ejection units 5, and the ink stored in the liquid container 3 is supplied. Then, the drive module 10 controls an operation of the ejection module 20 based on the image information signal IP. As a result, the ejection module 20 ejects the ink supplied from the liquid container 3 at a predetermined timing corresponding to the control of the drive module 10.

In the liquid ejecting apparatus 1 of the present embodiment, the ejection modules 20 included in each of the plurality of ejection units 5 are located side by side along the main scanning direction so as to be equal to or greater than a width of the medium P. Then, each of the plurality of ejection units 5 ejects ink at a timing synchronized with the transport of the medium P. As a result, the ink ejected from each of the plurality of ejection units 5 lands at a desired position on the medium P, and a desired image is formed at the medium P.

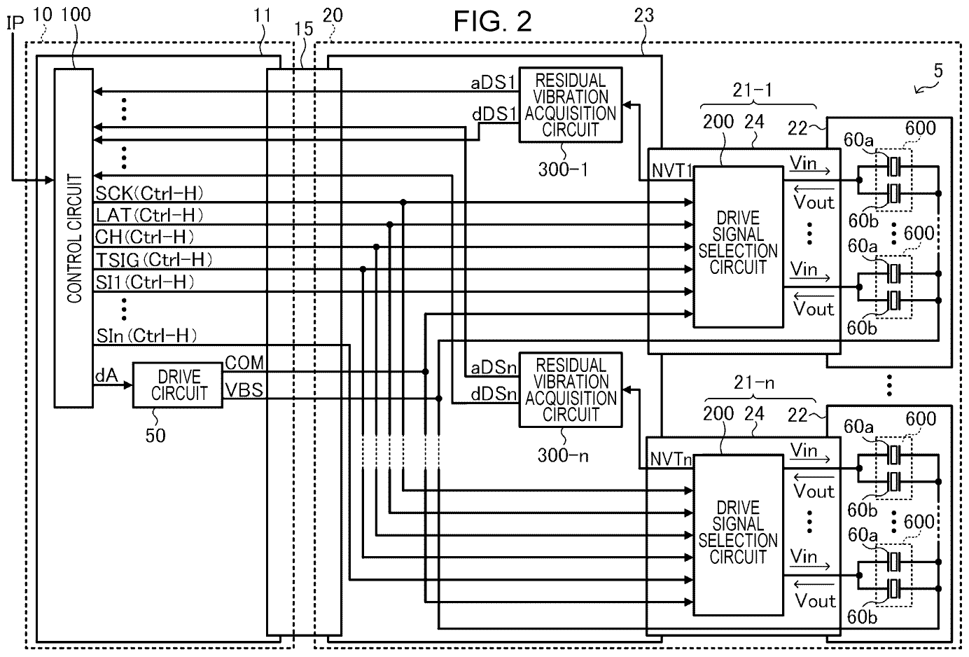

Next, a schematic configuration of the ejection unit 5 will be described. FIG. 2 is a diagram illustrating the schematic configuration of the ejection unit 5. As illustrated in FIG. 2, the ejection unit 5 includes the drive module 10 and the ejection module 20. In the ejection unit 5, the drive module 10 and the ejection module 20 are electrically coupled to each other via a cable 15. Here, as the cable 15 that electrically couples the drive module 10 and the ejection module 20, a flexible flat cable (FFC) or a flexible printed circuit (FPC) can be used. The drive module 10 and the ejection module 20 may be electrically coupled to each other by a board to board (BtoB) connector without using the cable 15, or may be electrically coupled to each other by using the cable 15 and the BtoB connector in combination.

The drive module 10 includes a control circuit substrate 11, a drive circuit 50, and a control circuit 100. The control circuit substrate 11 is a printed substrate having one or a plurality of wiring layers, and a glass epoxy substrate, a glass polyimide substrate, or the like can be used. Each element constituting the drive module 10, including the drive circuit 50 and the control circuit 100, is mounted on the control circuit substrate 11. The control circuit substrate 11 on which each element constituting the drive module 10 is mounted may be configured by one printed substrate or may be configured by a plurality of printed substrates.

The control circuit 100 is configured as one or a plurality of integrated circuit devices including a processing circuit such as a CPU or an FPGA and a storage circuit such as a semiconductor memory. The image information signal IP output by the control unit 2 is input to the control circuit 100. The control circuit 100 generates and outputs a signal for controlling the operation of the drive module 10 and the ejection module 20 based on the input image information signal IP.

Specifically, the control circuit 100 generates a clock signal SCK, a latch signal LAT, a change signal CH, an inspection timing signal TSIG, and print data signals SI1 to SIn based on the input image information signal IP, and outputs the generated signals to the ejection module 20.

In addition, the control circuit 100 generates a base drive signal dA and outputs the base drive signal dA to the drive circuit 50. The drive circuit 50 generates a drive signal COM including a signal waveform defined by the input base drive signal dA, and outputs the drive signal COM to the ejection module 20. Specifically, the control circuit 100 generates a base drive signal dA of a digital signal and outputs the base drive signal dA to the drive circuit 50. The drive circuit 50 generates the drive signal COM by converting the base drive signal dA of the input digital signal into an analog signal and then performing class D amplification on the converted analog signal. Then, the drive circuit 50 outputs the generated drive signal COM to the ejection module 20. That is, the base drive signal dA output by the control circuit 100 defines a signal waveform of the drive signal COM output by the drive circuit 50.

The base drive signal dA input to the drive circuit 50 may be any signal as long as the base drive signal dA can define the signal waveform of the drive signal COM, and may be an analog signal. In addition, the drive circuit 50 need only generate the drive signal COM by amplifying the signal waveform defined by the base drive signal dA, and may generate the drive signal COM by performing class A amplification, class B amplification, or class AB amplification instead of class D amplification.

In addition, the drive circuit 50 generates a reference voltage signal VBS and outputs the reference voltage signal VBS to the ejection module 20. The reference voltage signal VBS is a signal having a constant voltage value that defines a reference potential for driving piezoelectric elements 60a and 60b included in the ejection section 600 described later. The voltage value of the reference voltage signal VBS may be, for example, a ground potential GND, or may be 5.5 V, 6 V, or the like. In FIG. 2, it is illustrated that the drive circuit 50 generates the reference voltage signal VBS and outputs the reference voltage signal VBS to the ejection module 20, but the reference voltage signal VBS may be generated by a constant voltage output circuit (not illustrated) or the like configured separately from the drive circuit 50.

Further, state signals aDS1 to aDSn and dDS1 to dDSn are input to the control circuit 100 from the ejection module 20 to be described later. The control circuit 100 acquires state information of the ejection section 600 included in the ejection module 20 based on the input state signals aDS1 to aDSn and dDS1 to dDSn. Then, the control circuit 100 corrects the clock signal SCK, the latch signal LAT, the change signal CH, the inspection timing signal TSIG, and the print data signals SI1 to SIn based on the acquired state information of the ejection section 600. As a result, an ejection accuracy of the ink ejected from the ejection module 20 can be improved.

The ejection module 20 includes print heads 21-1 to 21-n, a head circuit substrate 23, and residual vibration acquisition circuits 300-1 to 300-n. In addition, each of the print heads 21-1 to 21-n includes a head chip 22, a flexible substrate 24, and a drive signal selection circuit 200. Each of the head chips 22 included in each of the print heads 21-1 to 21-n includes a plurality of ejection sections 600, and each of the plurality of ejection sections 600 includes the piezoelectric elements 60a and 60b.

The clock signal SCK, the latch signal LAT, the change signal CH, the inspection timing signal TSIG, the print data signals SI1 to SIn, the drive signal COM, and the reference voltage signal VBS output by the drive module 10 are input to the ejection module 20.

The head circuit substrate 23 propagates the input clock signal SCK, latch signal LAT, change signal CH, inspection timing signal TSIG, print data signals SI1 to SIn, drive signal COM, and reference voltage signal VBS to the corresponding print heads 21-1 to 21-n. The head circuit substrate 23 is a printed substrate having one or a plurality of wiring layers, and for example, a glass epoxy substrate, a glass polyimide substrate, or the like can be used.

Among the clock signal SCK, the latch signal LAT, the change signal CH, the inspection timing signal TSIG, the print data signals SI1 to SIn, the drive signal COM, and the reference voltage signal VBS, the head circuit substrate 23 propagates the clock signal SCK, the latch signal LAT, the change signal CH, the inspection timing signal TSIG, the print data signal SI1, the drive signal COM, and the reference voltage signal VBS to the print head 21-1.

Among the clock signal SCK, the latch signal LAT, the change signal CH, the inspection timing signal TSIG, the print data signal SI1, the drive signal COM, and the reference voltage signal VBS input to the print head 21-1, the clock signal SCK, the latch signal LAT, the change signal CH, the inspection timing signal TSIG, the print data signal SI1, and the drive signal COM are input to the drive signal selection circuit 200 of the print head 21-1. The drive signal selection circuit 200 of the print head 21-1 generates a drive voltage signal Vin corresponding to each of the plurality of ejection sections 600 included in the head chip 22 of the print head 21-1 by selecting or not selecting the signal waveform included in the drive signal COM based on the input clock signal SCK, latch signal LAT, change signal CH, inspection timing signal TSIG, and print data signal SI1, and supplies the drive voltage signal Vin to one end of the piezoelectric elements 60a and 60b included in the corresponding ejection section 600.

At this time, the reference voltage signal VBS is supplied to the other ends of the piezoelectric elements 60a and 60b included in each of the plurality of ejection sections 600 included in the head chip 22 of the print head 21-1. Then, the piezoelectric elements 60a and 60b included in the plurality of ejection sections 600 are driven corresponding to a potential difference between a voltage value of the drive voltage signal Vin supplied to one end and the voltage value of the reference voltage signal VBS supplied to the other end. Ink is ejected from the corresponding ejection section 600 by driving the piezoelectric elements 60a and 60b.

In addition, a residual vibration signal Vout corresponding to residual vibration generated after the piezoelectric elements 60a and 60b included in the plurality of ejection sections 600 included in the head chip 22 of the print head 21-1 are driven is input to the drive signal selection circuit 200 of the print head 21-1. The drive signal selection circuit 200 generates an acquisition residual vibration signal NVT1 corresponding to the input residual vibration signal Vout, and outputs the acquisition residual vibration signal NVT1 from the print head 21-1.

The drive signal selection circuit 200 included in the print head 21-1 is configured as an integrated circuit device and is chip on film (COF)-mounted on the flexible substrate 24 included in the print head 21-1.

Similarly, among the clock signal SCK, the latch signal LAT, the change signal CH, the inspection timing signal TSIG, the print data signals SI1 to SIn, the drive signal COM, and the reference voltage signal VBS, the head circuit substrate 23 propagates the clock signal SCK, the latch signal LAT, the change signal CH, the inspection timing signal TSIG, the print data signal SIi (i is any of 1 to n), the drive signal COM, and the reference voltage signal VBS to the print head 21-i.

Among the clock signal SCK, the latch signal LAT, the change signal CH, the inspection timing signal TSIG, the print data signal SIi, the drive signal COM, and the reference voltage signal VBS input to the print head 21-i, the clock signal SCK, the latch signal LAT, the change signal CH, the inspection timing signal TSIG, the print data signal SIi, and the drive signal COM are input to the drive signal selection circuit 200 of the print head 21-i. The drive signal selection circuit 200 of the print head 21-i generates the drive voltage signal Vin corresponding to each of the plurality of ejection sections 600 included in the head chip 22 of the print head 21-i by selecting or not selecting the signal waveform included in the drive signal COM based on the input clock signal SCK, latch signal LAT, change signal CH, inspection timing signal TSIG, and print data signal SIi, and supplies the drive voltage signal Vin to the one end of the piezoelectric elements 60a and 60b included in the corresponding ejection section 600 in common.

At this time, the reference voltage signal VBS is supplied to the other ends of the piezoelectric elements 60a and 60b included in each of the plurality of ejection sections 600 included in the head chip 22 of the print head 21-i. Then, the piezoelectric elements 60a and 60b included in the plurality of ejection sections 600 are driven corresponding to a potential difference between a voltage value of the drive voltage signal Vin supplied to one end and the voltage value of the reference voltage signal VBS supplied to the other end. Ink is ejected from the corresponding ejection section 600 by driving the piezoelectric elements 60a and 60b.

In addition, the residual vibration signal Vout corresponding to the residual vibration generated after the piezoelectric elements 60a and 60b included in the plurality of ejection sections 600 of the head chip 22 of the print head 21-i are driven is input to the drive signal selection circuit 200 of the print head 21-i. The drive signal selection circuit 200 generates an acquisition residual vibration signal NVTi corresponding to the input residual vibration signal Vout, and outputs the acquisition residual vibration signal NVTi from the print head 21-i.

The drive signal selection circuit 200 included in the print head 21-i is configured as an integrated circuit device and is COF-mounted on the flexible substrate 24 included in the print head 21-i.

Here, the drive signal selection circuit 200 included in each of the print heads 21-1 to 21-i is not limited to a case of being COF-mounted on the corresponding flexible substrate 24, and may be provided on the head circuit substrate 23. However, as described in the present embodiment, it is preferable that the drive signal selection circuit 200 is COF-mounted on the corresponding flexible substrate 24. Therefore, a propagation path of the drive voltage signal Vin output by the drive signal selection circuit 200 and a propagation path of the residual vibration signal Vout input to the drive signal selection circuit 200 can be shortened, a possibility that noise is superimposed on the drive voltage signal Vin and the residual vibration signal Vout is reduced, and a possibility that the signal waveforms of the drive voltage signal Vin and the residual vibration signal Vout are distorted due to an influence of impedance of the propagation paths is reduced. As a result, an accuracy of the signal waveform of the drive voltage signal Vin supplied to the piezoelectric elements 60a and 60b included in the corresponding ejection section 600 is improved, a drive accuracy of the piezoelectric elements 60a and 60b is improved, and an accuracy of determining whether or not the ejection section 600 corresponding to the residual vibration signal Vout in the control circuit 100 is normal is improved.

The residual vibration acquisition circuits 300-1 to 300-n are provided on the head circuit substrate 23 in correspondence with the print heads 21-1 to 21-n. Specifically, the residual vibration acquisition circuit 300-1 is provided in correspondence with the print head 21-1, and the acquisition residual vibration signal NVT1 output by the drive signal selection circuit 200 of the print head 21-1 is input to the residual vibration acquisition circuit 300-1. Then, the residual vibration acquisition circuit 300-1 determines a state of the corresponding ejection section 600 based on the input acquisition residual vibration signal NVT1, and outputs the state signals aDS1 and dDS1 according to the determination result.

Similarly, the residual vibration acquisition circuit 300-i is provided in correspondence with the print head 21-i, and the acquisition residual vibration signal NVTi output by the drive signal selection circuit 200 of the print head 21-i is input to the residual vibration acquisition circuit 300-i. Then, the residual vibration acquisition circuit 300-i determines the state of the corresponding ejection section 600 based on the input acquisition residual vibration signal NVTi, and outputs the state signals aDSi and dDSi according to the determination result. The residual vibration acquisition circuits 300-1 to 300-n may be configured as individual integrated circuit devices, or may be configured as one integrated circuit device together with the drive signal selection circuit 200 included in the corresponding print heads 21-1 to 21-n. In addition, a part or all of the residual vibration acquisition circuits 300-1 to 300-n may be integrally configured with the control circuit 100 mounted on the control circuit substrate 11 in the drive module 10.

Here, the print heads 21-1 to 21-n all have the same configuration. Therefore, in the following description, when it is not necessary to distinguish the print heads 21-1 to 21-n, the print heads 21-1 to 21-n may be simply referred to as a print head 21. At this time, the description will be made on the assumption that the clock signal SCK, the latch signal LAT, the change signal CH, the inspection timing signal TSIG, print data signal SI as the print data signals SI1 to SIn, the drive signal COM, and the reference voltage signal VBS are input to the print head 21, and the acquisition residual vibration signal NVT as the acquisition residual vibration signals NVT1 to NVIn is output. In addition, the residual vibration acquisition circuits 300-1 to 300-n all have the same configuration. Therefore, in the following description, when it is not necessary to distinguish the residual vibration acquisition circuits 300-1 to 300-n, the residual vibration acquisition circuits 300-1 to 300-n may be simply referred to as a residual vibration acquisition circuit 300. At this time, the description will be made on the assumption that the acquisition residual vibration signal NVT as the acquisition residual vibration signals NVT1 to NVIn is input to the residual vibration acquisition circuit 300, and the residual vibration acquisition circuit 300 outputs a state signal aDS as the state signals aDS1 to aDSn and a state signal dDS as the state signals dDS1 to dDSn.

### 2. Configuration and Operation of Drive Signal Selection Circuit

### 2.1. Signal Waveform of Drive Signal COM

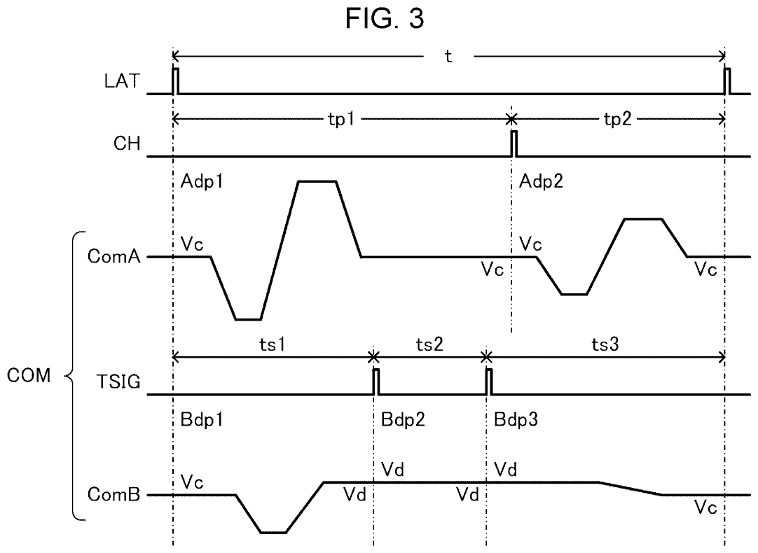

Next, a configuration and an operation of the drive signal selection circuit 200 that outputs the drive voltage signal Vin corresponding to each of the plurality of ejection sections 600 by selecting or not selecting the signal waveform included in the drive signal COM will be described. In describing the details of the drive signal selection circuit 200, first, an example of the signal waveform of the drive signal COM input to the drive signal selection circuit 200 will be described. FIG. 3 is a diagram illustrating an example of the signal waveform of the drive signal COM. As illustrated in FIG. 3, the drive signal COM includes a drive signal ComA and a drive signal ComB.

The drive signal ComA includes drive waveforms Adp1 and Adp2 as signal waveforms in a cycle t until the latch signal LAT rises next after the latch signal LAT rises.

The drive waveform Adp1 is disposed in a period tp1 from the rise of the latch signal LAT to the rise of the change signal CH in the cycle t. The drive waveform Adp1 starts with a voltage value of a voltage Vc, the voltage value changes to drive the piezoelectric elements 60a and 60b, and the drive waveform Adp1 ends with the voltage value of the voltage Vc. When the drive waveform Adp1 is supplied to the piezoelectric elements 60a and 60b, a predetermined amount of ink is ejected from the corresponding ejection section 600.

The drive waveform Adp2 is disposed in a period tp2 from the rise of the change signal CH to the rise of the latch signal LAT in the cycle t. The drive waveform Adp2 starts with a voltage value of the voltage Vc, the voltage value changes to drive the piezoelectric elements 60a and 60b, and the drive waveform Adp2 ends with the voltage value of the voltage Vc. When the drive waveform Adp2 is supplied to the piezoelectric elements 60a and 60b, a smaller amount of ink than the predetermined amount is ejected from the corresponding ejection section 600.

Here, in the following description, the amount of ink corresponding to the predetermined amount of ink ejected from the ejection section 600 when the drive waveform Adp1 is supplied to the piezoelectric elements 60a and 60b may be referred to as a medium amount, and the amount of ink corresponding to the smaller amount than the predetermined amount of ink ejected from the ejection section 600 when the drive waveform Adp2 is supplied to the piezoelectric elements 60a and 60b may be referred to as a small amount. The drive signal ComB includes drive waveforms Bdp1, Bdp2, and Bdp3 as signal waveforms in the cycle t.

The drive waveform Bdp1 is disposed in a period ts1 from the rise of the latch signal LAT to the rise of the inspection timing signal TSIG in the cycle t. The drive waveform Bdp1 starts with the voltage value of the voltage Vc, the voltage value changes to drive the piezoelectric elements 60a and 60b, and the drive waveform Bdp1 ends with the voltage value of a voltage Vd. When the drive waveform Bdp1 is supplied to the piezoelectric elements 60a and 60b, ink is not ejected from the corresponding ejection section 600, and the piezoelectric elements 60a and 60b are driven so that predetermined vibration is generated in the corresponding ejection section 600.

The drive waveform Bdp2 is disposed in a period ts2 from the rise of the inspection timing signal TSIG that defines the end of the period ts1 in the cycle t to the rise of the next inspection timing signal TSIG. In the drive waveform Bdp2, a voltage value is constant at the voltage Vd. When the drive waveform Bdp2 is supplied to one end of the piezoelectric elements 60a and 60b, the piezoelectric elements 60a and 60b are not driven, and thus, ink is not ejected from the corresponding ejection section 600.

The drive waveform Bdp3 is disposed in a period ts3 from the rise of the inspection timing signal TSIG that defines the end of the period ts2 in the cycle t to the rise of the next latch signal LAT. The drive waveform Bdp3 starts with a voltage value of the voltage Vd and ends by the voltage value becoming the voltage Vc thereafter. When the drive waveform Bdp3 is supplied to the piezoelectric elements 60a and 60b, the piezoelectric elements 60a and 60b are not driven, and thus, ink is not ejected from the corresponding ejection section 600.

That is, the drive circuit 50 outputs the drive signal COM including the drive signal ComA including the drive waveforms Adp1 and Adp2, and the drive signal ComB including the drive waveforms Bdp1, Bdp2, and Bdp3 to the drive signal selection circuit 200. Then, the drive signal selection circuit 200 generates the drive voltage signal Vin including a signal waveform for expressing four gradations of a large dot LD, a medium dot MD, a small dot SD, and a non-record ND on the medium P, and the drive voltage signal Vin including a signal waveform for executing state inspection CD for inspecting the state of the ejection section 600, by selecting or not selecting the drive waveforms Adp1 and Adp2, and the drive waveforms Bdp1, Bdp2, and Bdp3, and outputs the drive voltage signals Vin to the corresponding ejection section 600.

The signal waveform of the drive signal COM illustrated in FIG. 3 is an example, and the drive circuit 50 may output the drive signal COM including various shapes of signal waveforms corresponding to the type of the ink to be ejected, the type of the medium P on which the ink lands, and the like. In addition, the drive circuit 50 may generate the drive signal COM including the signal waveform corresponding to each of the print heads 21-1 to 21-n and output the drive signal COM to the corresponding print heads 21-1 to 21-n.

### 2.2. Configuration of Drive Signal Selection Circuit

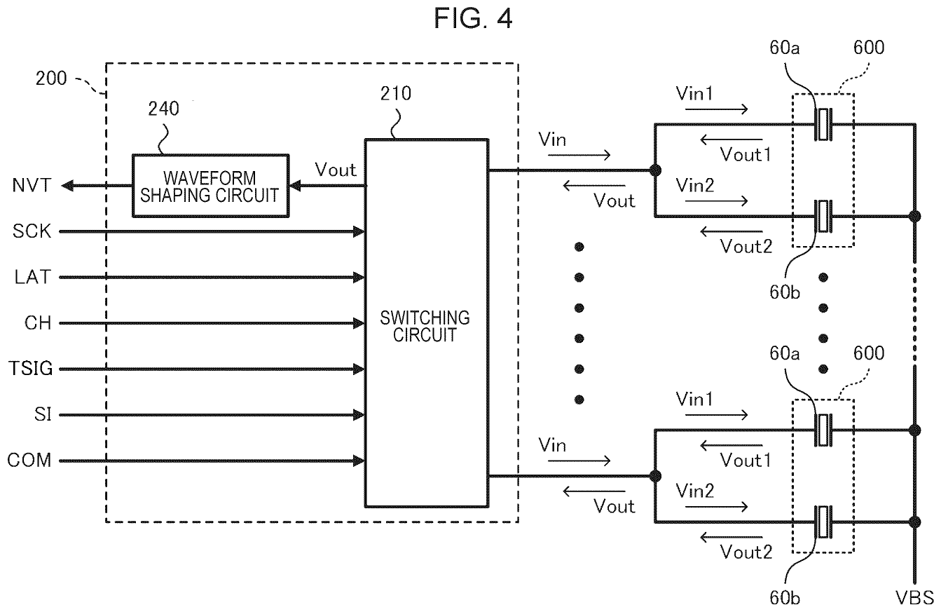

Next, a specific example of the configuration of the drive signal selection circuit 200 will be described. FIG. 4 is a diagram illustrating an example of a functional configuration of the drive signal selection circuit 200. As illustrated in FIG. 4, the drive signal selection circuit 200 includes a switching circuit 210 and a waveform shaping circuit 240.

The clock signal SCK, the latch signal LAT, the change signal CH, the inspection timing signal TSIG, the print data signal SI, and the drive signal COM are input to the switching circuit 210. The switching circuit 210 generates the drive voltage signal Vin corresponding to each of the plurality of ejection sections 600 by selecting or not selecting each of the drive waveforms Adp1 and Adp2 included in the drive signal ComA among the drive signals Com, and each of the drive waveforms Bdp1, Bdp2, and Bdp3 included in the drive signal ComB, based on the input clock signal SCK, latch signal LAT, inspection timing signal TSIG, change signal CH, and print data signal SI. Then, the drive voltage signal Vin generated by the switching circuit 210 is output from the drive signal selection circuit 200.

The drive voltage signal Vin output from the drive signal selection circuit 200 is supplied to the piezoelectric element 60a and the piezoelectric element 60b included in the corresponding ejection section 600. Here, in the following description, when the drive voltage signal Vin supplied to the piezoelectric element 60a and the drive voltage signal Vin supplied to the piezoelectric element 60b are distinguished from each other, the drive voltage signal Vin supplied to the piezoelectric element 60a may be referred to as a drive voltage signal Vin1, and the drive voltage signal Vin supplied to the piezoelectric element 60b may be referred to as a drive voltage signal Vin2.

In addition, the switching circuit 210 acquires the residual vibration signal Vout corresponding to the residual vibration generated in the ejection section 600 after the piezoelectric elements 60a and 60b are driven by the drive voltage signal Vin output by the drive signal selection circuit 200.

Specifically, after the drive voltage signal Vin1 is supplied to the piezoelectric element 60a and the drive voltage signal Vin2 is supplied to the piezoelectric element 60b, residual vibration is generated in the ejection section 600. Then, the piezoelectric element 60a outputs reverse electromotive force generated corresponding to the residual vibration as a residual vibration signal Vout1, and the piezoelectric element 60b outputs the reverse electromotive force generated corresponding to the residual vibration as a residual vibration signal Vout2. Therefore, the residual vibration signal Vout in which the residual vibration signal Vout1 and the residual vibration signal Vout2 are combined is input to the drive signal selection circuit 200. The switching circuit 210 acquires the input residual vibration signal Vout at a predetermined timing. Then, the switching circuit 210 outputs the acquired residual vibration signal Vout to a waveform shaping circuit 240.

The waveform shaping circuit 240 shapes a signal waveform of the input residual vibration signal Vout. Then, the waveform shaping circuit 240 outputs a signal obtained by shaping the signal waveform of the residual vibration signal Vout as the acquisition residual vibration signal NVT. The acquisition residual vibration signal NVT output by the waveform shaping circuit 240 is output from the drive signal selection circuit 200 and input to the residual vibration acquisition circuit 300.

### 2.2.1. Configuration of Switching Circuit

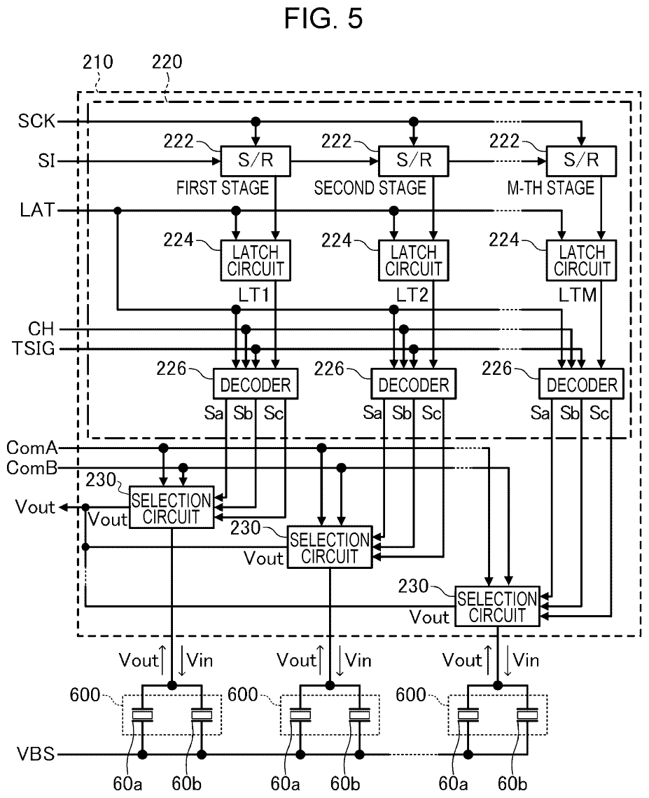

A specific example of a configuration and an operation of the switching circuit 210 included in the drive signal selection circuit 200 will be described. FIG. 5 is a diagram illustrating an example of the functional configuration of the switching circuit 210. As illustrated in FIG. 5, the switching circuit 210 includes a selection control circuit 220 and a plurality of selection circuits 230.

The clock signal SCK, the print data signal SI, the latch signal LAT, the change signal CH, and the inspection timing signal TSIG are input to the selection control circuit 220. The selection control circuit 220 generates selection signals Sa, Sb, and Sc having predetermined logic levels in each of the periods tp1 and tp2 and the periods ts1, ts2, and ts3 based on the input clock signal SCK, print data signal SI, latch signal LAT, change signal CH, and inspection timing signal TSIG, and outputs the selection signals Sa, Sb, and Sc to the corresponding selection circuit 230.

The selection control circuit 220 includes a set of a shift register 222, a latch circuit 224, and a decoder 226 provided in correspondence with each of the plurality of ejection sections 600 included in the print head 21. Here, the description will be made on the assumption that the print head 21 has M ejection sections 600. That is, the selection control circuit 220 has M sets of the shift register 222, the latch circuit 224, and the decoder 226. In other words, the selection control circuit 220 includes M shift registers 222, M latch circuits 224, and M decoders 226.

The print data signal SI serially includes 3-bit print data SId[SIH, SIM, SIL] for selecting which of the large dot LD, the medium dot MD, the small dot SD, the non-record ND, and the state inspection CD described above to drive the ejection section 600 in correspondence with each of the M ejection sections 600. That is, the print data signal SI is a serial signal with a total of 3 M bits or more.

The print data signal SI is input to the selection control circuit 220 in synchronization with the clock signal SCK. The M shift registers 222 included in the selection control circuit 220 hold the 3-bit print data SId[SIH, SIM, SIL] included in the input print data signal SI in correspondence with the ejection section 600.

Specifically, the M shift registers 222 are coupled in cascade in correspondence with each of the M ejection sections 600. The print data signal SI that is serially input to the selection control circuit 220 is sequentially transferred to a subsequent stage of the M shift registers 222 coupled in cascade in synchronization with the clock signal SCK. When the supply of the clock signal SCK to the selection control circuit 220 is stopped, the M shift registers 222 hold the 3-bit print data SId[SIH, SIM, SIL] corresponding to the M ejection sections 600. In the following description, in order to distinguish the M shift registers 222 coupled in cascade, the M shift registers 222 may be referred to as a first stage, a second stage, . . . , and M-th stage in the order from an upstream to a downstream in which the print data signal SI is supplied.

Each of the M latch circuits 224 simultaneously latches the 3-bit print data SId[SIH, SIM, SIL] held by the corresponding shift register 222 at the rise of the latch signal LAT.

The print data SId[SIH, SIM, SIL] latched by the M latch circuits 224 is input to the corresponding decoder 226. Each of the M decoders 226 decodes the input print data SId[SIH, SIM, SIL], generates the selection signals Sa, Sb, and Sc of the logic level corresponding to the large dot LD, the medium dot MD, the small dot SD, the non-record ND, and the state inspection CD, and outputs the generated selection signals to the corresponding selection circuit 230.

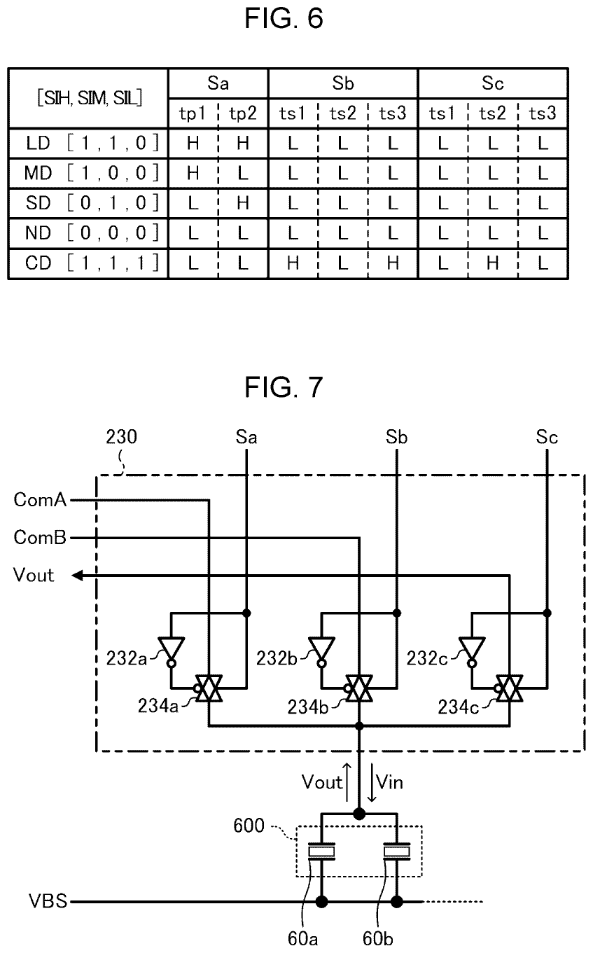

FIG. 6 is a diagram illustrating an example of decoding contents in the decoder 226. As illustrated in FIG. 6, when the print data SId[SIH, SIM, SIL]=[1, 1, 0] corresponding to the large dot LD is input, the decoder 226 sets the logic level of the selection signal Sa to H and H levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3.

In addition, when the print data SId[SIH, SIM, SIL]=[1, 0, 0] corresponding to the medium dot MD is input, the decoder 226 sets the logic level of the selection signal Sa to H and L levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3.

In addition, when the print data SId[SIH, SIM, SIL]=[0, 1, 0] corresponding to the small dot SD is input, the decoder 226 sets the logic level of the selection signal Sa to L and H levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3.

In addition, when the print data SId[SIH, SIM, SIL]=[0, 0, 0] corresponding to the non-record ND is input, the decoder 226 sets the logic level of the selection signal Sa to L and L levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3.

In addition, when the print data SId[SIH, SIM, SIL]=[1, 1, 1] corresponding to the state inspection CD is input, the decoder 226 sets the logic level of the selection signal Sa to the L and L levels in the periods tp1 and tp2, sets the logic level of the selection signal Sb to the H, L, and H levels in the periods ts1, ts2, and ts3, and sets the logic level of the selection signal Sc to the L, H, and L levels in the periods ts1, ts2, and ts3.

As described above, the selection control circuit 220 generates the selection signals Sa, Sb, and Sc of the logic level corresponding to each of the M ejection sections 600 based on the print data SId[SIH, SIM, SIL]. Then, the selection control circuit 220 outputs the generated selection signals Sa, Sb, and Sc to the corresponding selection circuits 230.

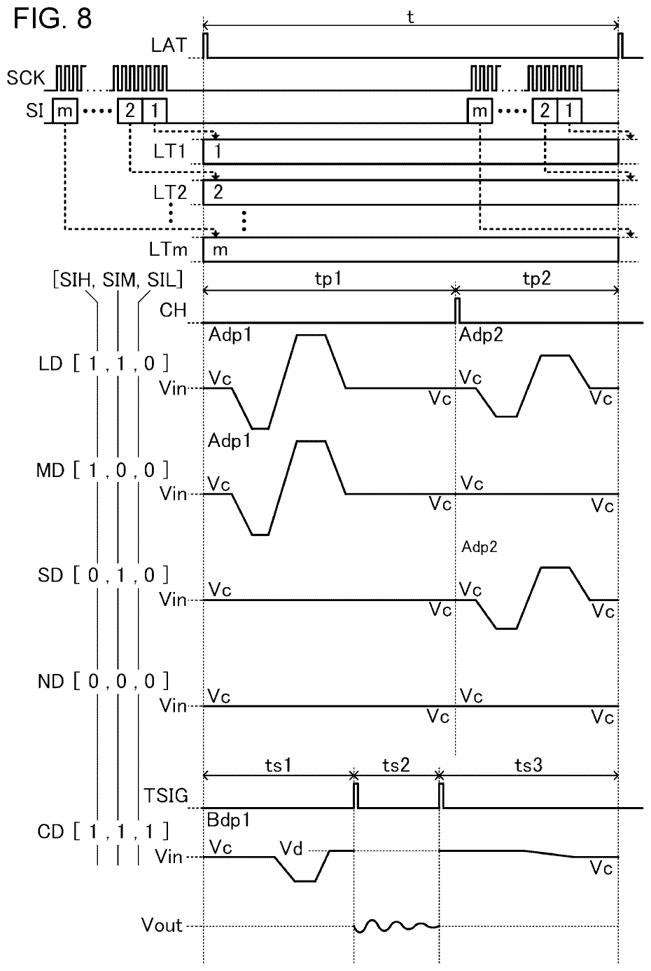

The selection circuit 230 is provided in correspondence with each of the M ejection sections 600. That is, the switching circuit 210 includes M selection circuits 230. Then, the drive signal COM is input to each of the M selection circuits 230, and each of the M selection circuits 230 switches whether or not to output the drive voltage signal Vin corresponding to the drive signal COM to the corresponding ejection section 600. FIG. 7 is a diagram illustrating a configuration of the selection circuit 230 corresponding to one ejection section 600. As illustrated in FIG. 7, the selection circuit 230 includes logic inversion circuits 232a, 232b, and 232c and transfer gates 234a, 234b, and 234c.

The selection signal Sa is supplied to a positive control end of the transfer gate 234a and is also supplied to a negative control end of the transfer gate 234a after the logic level is inverted by the logic inversion circuit 232a. The selection signal Sb is supplied to a positive control end of the transfer gate 234b and is also supplied to a negative control end of the transfer gate 234b after the logic level is inverted by the logic inversion circuit 232b. The selection signal Sc is supplied to a positive control end of the transfer gate 234c and is also supplied to a negative control end of the transfer gate 234c after the logic level is inverted by the logic inversion circuit 232c.

Moreover, the drive signal ComA is supplied to an input end of the transfer gate 234a, and the drive signal ComB is supplied to an input end of the transfer gate 234b. Output ends of the transfer gates 234a and 234b are coupled to each other. The output ends of the transfer gates 234a and 234b coupled to each other are electrically coupled to the piezoelectric elements 60a and 60b included in the corresponding ejection section 600. In addition, an input end of the transfer gate 234c is coupled to the output ends of the transfer gates 234a and 234b which are coupled to each other, and an output end is electrically coupled to the piezoelectric elements 60a and 60b included in the corresponding ejection section 600. At this time, the output end of the transfer gate 234c is commonly coupled to the output end of the transfer gate 234c of the M selection circuits 230 included in the switching circuit 210 as illustrated in FIG. 5. That is, the output ends of the transfer gates 234c of the M selection circuits 230 included in the switching circuit 210 are electrically coupled to each other at the coupling point.

In the selection circuit 230 configured as described above, the transfer gate 234a is conductive between the input end and the output end when the logic level of the selection signal Sa is H level, and is non-conductive between the input end and the output end when the logic level of the selection signal Sa is L level. Similarly, the transfer gate 234b is conductive between the input end and the output end when the logic level of the selection signal Sb is H level, and is non-conductive between the input end and the output end when the logic level of the selection signal Sb is L level. Similarly, the transfer gate 234c is conductive between the input end and the output end when the logic level of the selection signal Sc is H level, and is non-conductive between the input end and the output end when the logic level of the selection signal Sc is L level. Here, in the following description, the fact that the transfer gates 234a, 234b, and 234c are conductive between the input end and the output end may be referred to as “on”, and the fact that the transfer gates 234a, 234b, and 234c are non-conductive between the input end and the output end may be referred to as “off”.

When the transfer gate 234a is turned on, the drive signal ComA is output from the switching circuit 210 as the drive voltage signal Vin, and when the transfer gate 234b is turned on, the drive signal ComB is output from the switching circuit 210 as the drive voltage signal Vin. The drive voltage signal Vin output from the switching circuit 210 is supplied to the piezoelectric elements 60a and 60b included in the corresponding ejection section 600. Further, when the transfer gate 234c is turned on, the switching circuit 210 acquires the residual vibration signal Vout corresponding to the residual vibration generated in the corresponding ejection section 600. The residual vibration signal Vout acquired by the switching circuit 210 is input to the waveform shaping circuit 240. That is, the waveform shaping circuit 240 is electrically coupled to a coupling point where the output ends of the transfer gates 234c of the M selection circuits 230 are commonly coupled.

An operation of the switching circuit 210 configured as described above will be described in detail. FIG. 8 is a diagram illustrating an example of the operation of the switching circuit 210. The print data signal SI is serially supplied to the switching circuit 210 in synchronization with the clock signal SCK. The print data signal SI input to the switching circuit 210 is sequentially transferred to the shift register 222 of the subsequent stage in synchronization with the clock signal SCK. When the supply of the clock signal SCK to the switching circuit 210 is stopped, the 3-bit print data SId[SIH, SIM, SIL] corresponding to the M ejection sections 600 is held in each of the M shift registers 222.

Thereafter, when the latch signal LAT rises, each of the latch circuits 224 simultaneously latches the print data SId[SIH, SIM, SIL] held in the shift register 222. Here, LT1, LT2, . . . , and LTM illustrated in FIG. 8 indicate the print data SId[SIH, SIM, SIL] held by the shift registers 222 of the first stage, the second stage, . . . , the M-th stage and latched by the corresponding latch circuit 224.

The decoder 226 decodes the latched print data SId[SIH, SIM, SIL] with the content illustrated in FIG. 8. Then, the decoder 226 outputs the selection signals Sa, Sb, and Sc having the logic levels illustrated in FIG. 8 in the cycle t.

Specifically, when the print data SId[SIH, SIM, SIL]=[1, 1, 0], the decoder 226 sets the logic level of the selection signal Sa to H and H levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 selects the drive waveform Adp1 of the drive signal ComA in the period tp1, and selects the drive waveform Adp2 of the drive signal ComA in the period tp2. As a result, the switching circuit 210 outputs the drive voltage signal Vin corresponding to the large dot LD illustrated in FIG. 8. When the drive voltage signal Vin corresponding to the large dot LD is supplied to the ejection section 600, a medium amount of ink is ejected in the period tp1, and a small amount of ink is ejected in the period tp2, from the ejection section 600. Then, in the cycle t, the medium amount of ink and the small amount of ink land on the medium P and are bonded to each other, so that the large dot LD is formed at the medium P.

In addition, when the print data SId[SIH, SIM, SIL]=[1, 0, 0], the decoder 226 sets the logic level of the selection signal Sa to the H and L levels in the periods tp1 and tp2, sets the logic level of the selection signal Sb to the L, L, and L levels in the periods ts1, ts2, and ts3, and sets the logic level of the selection signal Sc to the L, L, and L levels in the periods ts1, ts2, and ts3. Accordingly, the selection circuit 230 selects the drive waveform Adp1 of the drive signal ComA in the period tp1, and selects signal waveforms for neither of the drive signals ComA nor ComB in the period tp2. As a result, the switching circuit 210 outputs the drive voltage signal Vin corresponding to the medium dot MD illustrated in FIG. 8. When the drive voltage signal Vin corresponding to the medium dot MD is supplied to the ejection section 600, a medium amount of ink is ejected from the ejection section 600 in the period tp1, and ink is not ejected in the period tp2. As a result, in the cycle t, a medium amount of ink lands on the medium P, and the medium dot MD is formed at the medium P.

In addition, when the print data SId[SIH, SIM, SIL]=[0, 1, 0], the decoder 226 sets the logic level of the selection signal Sa to L and H levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 selects signal waveforms for neither of the drive signals ComA nor ComB in the period tp1, and selects the drive waveform Adp2 of the drive signal ComA in the period tp2. As a result, the switching circuit 210 outputs the drive voltage signal Vin corresponding to the small dot SD illustrated in FIG. 8. When the drive voltage signal Vin corresponding to the small dot SD is supplied to the ejection section 600, ink is not ejected in the period tp1, and a small amount of ink is ejected in the period tp2, from the ejection section 600. As a result, in the cycle t, a small amount of ink lands on the medium P, and the small dot SD is formed at the medium P.

In addition, when the print data SId[SIH, SIM, SIL]=[0, 0, 0], the decoder 226 sets the logic level of the selection signal Sa to L and L levels in the periods tp1 and tp2, sets the logic level of the selection signal Sb to L, L, and L levels in the periods ts1, ts2, and ts3, and sets the logic level of the selection signal Sc to L, L, and L levels in the periods ts1, ts2, and ts3. As a result, the selection circuit 230 selects neither of the signal waveforms of the drive signals ComA nor ComB in the period tp1 and selects signal waveforms for neither of the signal waveforms of the drive signals ComA nor ComB in the period tp2. As a result, the switching circuit 210 outputs the drive voltage signal Vin corresponding to the non-record ND illustrated in FIG. 8. When the drive voltage signal Vin corresponding to the non-record ND is supplied to the ejection section 600, ink is not ejected in the period tp1 and ink is not ejected in the period tp2, from the ejection section 600. As a result, ink does not land on the medium P and dots are not formed at the medium P in the cycle t.

In addition, when the print data SId[SIH, SIM, SIL]=[1, 1, 1], the decoder 226 sets the logic level of the selection signal Sa to L and L levels in the periods tp1 and tp2, sets the logic level of the selection signal Sb to H, L, and H levels in the periods ts1, ts2, and ts3, and sets the logic level of the selection signal Sc to L, H, and L levels in the periods ts1, ts2, and ts3. As a result, the selection circuit 230 selects the drive waveform Bdp1 of the drive signal ComB in the period ts1, acquires the residual vibration signal Vout corresponding to the residual vibration generated in the ejection section 600 after the piezoelectric elements 60a and 60b are driven by the drive waveform Bdp1 in the period ts2, outputs the acquired residual vibration signal Vout from the switching circuit 210, and selects the drive waveform Bdp3 of the drive signal ComB in the period ts3. As a result, the switching circuit 210 outputs the drive voltage signal Vin corresponding to the state inspection CD illustrated in FIG. 8 in the periods ts1 and ts3, acquires the residual vibration signal Vout corresponding to the vibration generated in the ejection section 600 after the drive waveform Bdp1 is supplied to the ejection section 600 in the period ts2, and outputs the residual vibration signal Vout to the waveform shaping circuit 240. At this time, ink is not ejected from the ejection section 600 in the cycle t. As a result, ink does not land on the medium P and dots are not formed at the medium P in the cycle t.

As described above, the switching circuit 210 generates the drive voltage signal Vin by selecting or not selecting the drive waveforms Adp1 and Adp2 included in the drive signal ComA and the drive waveforms Bdp1, Bdp2, and Bdp3 included in the drive signal ComB, among the drive signal COM output by the drive circuit 50, based on the clock signal SCK, the print data signal SI, the latch signal LAT, the change signal CH, and the inspection timing signal TSIG. Then, the switching circuit 210 supplies the generated drive voltage signal Vin to the corresponding ejection section 600, acquires the residual vibration signal Vout generated after the drive voltage signal Vin is supplied to the ejection section 600, and outputs the residual vibration signal Vout to the waveform shaping circuit 240.

### 2.2.2 Configuration of Waveform Shaping Circuit

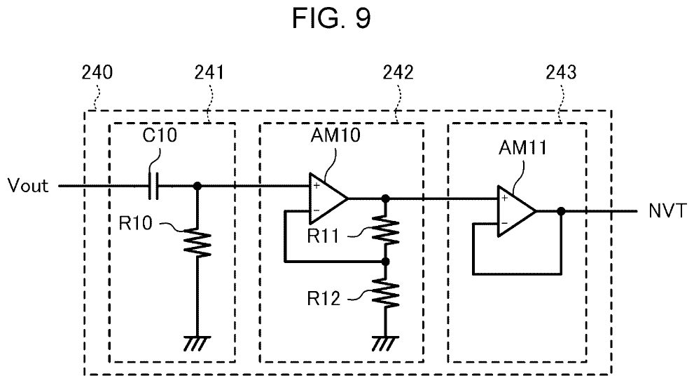

Next, a specific example of a configuration and an operation of the waveform shaping circuit 240 included in the drive signal selection circuit 200 will be described. FIG. 9 is a diagram illustrating an example of the configuration of the waveform shaping circuit 240. As illustrated in FIG. 9, the waveform shaping circuit 240 includes a filter circuit 241, an amplification circuit 242, and an impedance conversion circuit 243.

The filter circuit 241 includes a capacitor C10 and a resistor R10. The residual vibration signal Vout is supplied to one end of the capacitor C10. The other end of the capacitor C10 is electrically coupled to one end of the resistor R10. A ground potential is supplied to the other end of the resistor R10. As described above, the filter circuit 241 constitutes a high-pass filter. The filter circuit 241 reduces a low frequency component superimposed on the residual vibration signal Vout to extract a high frequency component superimposed on the residual vibration signal Vout. The filter circuit 241 may constitute a so-called band pass filter having a low pass filter in addition to the high-pass filter, and may extract a signal of a predetermined frequency component superimposed on the residual vibration signal Vout.

The amplification circuit 242 includes an operational amplifier AM10 and resistors R11 and R12. A signal output by the filter circuit 241 is input to a +side input terminal of the operational amplifier AM10. A-side input terminal of the operational amplifier AM10 is electrically coupled to one end of the resistor R11 and one end of the resistor R12. An output terminal of the operational amplifier AM10 is electrically coupled to the other end of the resistor R11. A ground potential is supplied to the other end of the resistor R12. The amplification circuit 242 configured as described above amplifies the signal output by the filter circuit 241 input to the +side input terminal of the operational amplifier AM10 at an amplification rate defined by resistance values of the resistors R11 and R12. That is, the amplification circuit 242 constitutes a non-inverting amplification circuit that amplifies an amplitude of a signal from which an alternating-current component of the residual vibration signal Vout is extracted at the amplification rate defined by the resistance values of the resistors R11 and R12. The amplification circuit 242 need only amplify the amplitude of the signal from which the alternating-current component of the residual vibration signal Vout is extracted at a predetermined amplification rate, and is not limited to the non-inverting amplification circuit.

The impedance conversion circuit 243 includes an operational amplifier AM11. A signal output by the amplification circuit 242 is input to a +side input terminal of the operational amplifier AM11. In addition, a −side input terminal of the operational amplifier AM11 is electrically coupled to an output terminal of the operational amplifier AM11. The impedance conversion circuit 243 configured as described above constitutes a so-called voltage follower circuit that outputs a signal having the same signal waveform as the signal waveform of the signal input to the +side input terminal of the operational amplifier AM11 from the output terminal of the operational amplifier AM11.

The waveform shaping circuit 240 outputs a signal output from the output terminal of the operational amplifier AM10 included in the amplification circuit 242, which is a signal output from the output terminal of the operational amplifier AM11 included in the impedance conversion circuit 243, as the acquisition residual vibration signal NVT.

The piezoelectric elements 60a and 60b included in the ejection section 600 to be inspected are driven by the drive voltage signal Vin corresponding to the state inspection CD being supplied, and then, high-frequency attenuation vibration is generated in the ejection section 600 to be inspected. The piezoelectric elements 60a and 60b output the residual vibration signals Vout1 and Vout2 corresponding to the attenuation vibration generated in the ejection section 600 to be inspected. That is, the switching circuit 210 acquires a signal of a composite wave of the residual vibration signals Vout1 and Vout2, which is a signal in which a signal waveform of the high-frequency attenuation vibration is combined, as the residual vibration signal Vout corresponding to the ejection section 600 to be inspected.

Since a voltage amplitude of the residual vibration signal Vout is weak, the residual vibration signal Vout is easily affected by noise. In the waveform shaping circuit 240 of the present embodiment, in the filter circuit 241, noise and a direct-current component of a low frequency component are removed from the residual vibration signal Vout, and a high frequency component included in the residual vibration signal Vout is extracted. A signal corresponding to the high-frequency attenuation vibration generated in the ejection section 600 to be inspected is extracted, and then, in the amplification circuit 242, the signal output by the filter circuit 241 is amplified. Therefore, resistance to noise is improved. The impedance conversion circuit 243 converts an impedance of the signal output by the amplification circuit 242, and thus, a stability of the acquisition residual vibration signal NVT output by the waveform shaping circuit 240 is improved. As a result, an acquisition accuracy of the residual vibration signal Vout, that is, a waveform accuracy of the acquisition residual vibration signal NVT is improved.

That is, the waveform shaping circuit 240 outputs a signal, which corresponds to the residual vibration signal Vout, shapes the signal waveform of the input residual vibration signal Vout, decreases the influence of noise or the like, and has a high stability and high resistance to noise, as the acquisition residual vibration signal NVT.

As described above, the switching circuit 210 included in the drive signal selection circuit 200 acquires the residual vibration signal Vout corresponding to the residual vibration generated in the ejection section 600, and the waveform shaping circuit 240 included in the drive signal selection circuit 200 outputs the acquisition residual vibration signal NVT corresponding to the residual vibration signal Vout by shaping the signal waveform of the residual vibration signal Vout. That is, the drive signal selection circuit 200 acquires the residual vibration signal Vout corresponding to the residual vibration generated in the ejection section 600, and outputs the acquisition residual vibration signal NVT corresponding to the residual vibration signal Vout.

### 3. Structure of Print Head

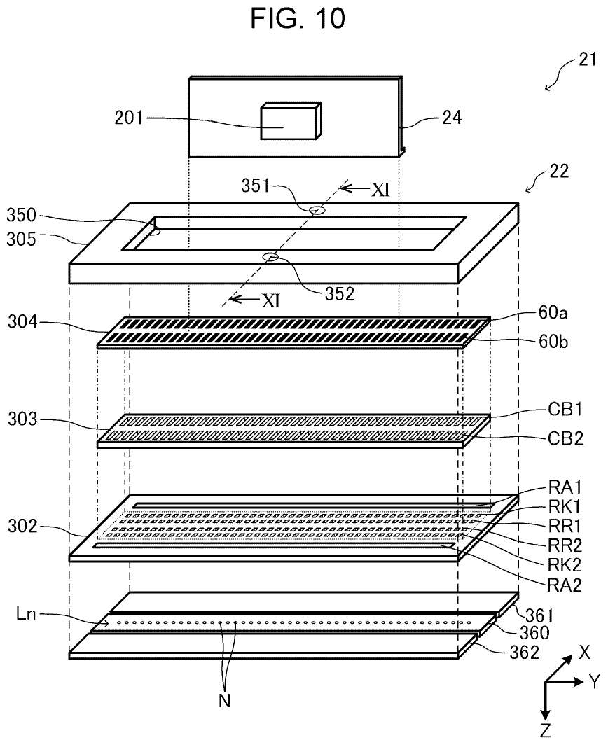

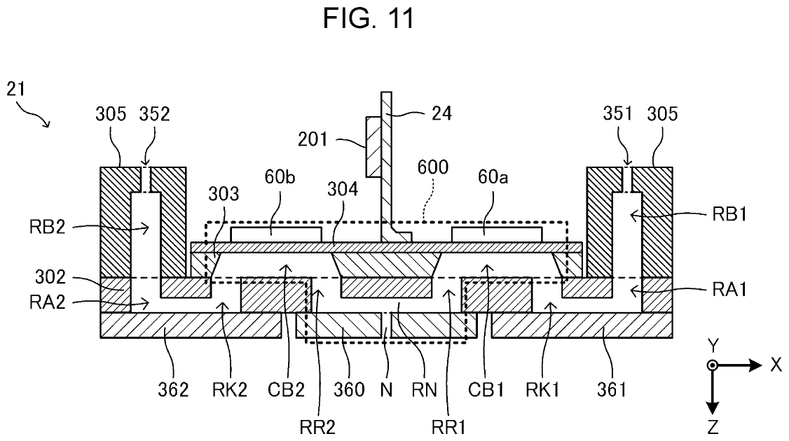

Next, a structure of the print head 21 will be described. FIG. 10 is an exploded perspective view of the print head 21, and FIG. 11 is a cross-sectional view taken along line XI-XI in FIG. 10. Here, in the following description, the description will be made using an X axis, a Y axis, and a Z axis that are orthogonal to each other. In the following description, a starting point side of an arrow along the X axis illustrated in the drawing may be referred to as a −X side, and a tip end side may be referred to as a +X side. A starting point side of an arrow along the Y axis illustrated in the drawing may be referred to as a −Y side, and a tip end side may be referred to as a +Y side. A starting point side of an arrow along the Z axis illustrated in the drawing may be referred to as a −Z side, and a tip end side may be referred to as a +Z side. Further, in the following description, the print head 21 will be described as having M ejection sections 600 as the plurality of ejection sections 600.

As illustrated in FIGS. 10 and 11, the print head 21 includes the head chip 22 and the flexible substrate 24. In addition, the head chip 22 includes a nozzle substrate 360, compliance sheets 361 and 362, a communication plate 302, a pressure chamber substrate 303, a vibration plate 304, and a storage chamber formation substrate 305.

The nozzle substrate 360 is a plate-shaped member that is elongated along the Y axis and extends substantially parallel to an XY plane formed by the X axis and the Y axis. M nozzles N are formed at the nozzle substrate 360. The nozzle N is a through-hole formed at the nozzle substrate 360. The M nozzles N are arranged side by side along the Y axis on the nozzle substrate 360, and thus a nozzle row Ln is formed at the nozzle substrate 360. Here, the substantially parallel is not limited to being completely parallel, and includes a case where the substantially parallel is considered to be parallel when an error or the like is taken into consideration.

The communication plate 302 is located on the −Z side of the nozzle substrate 360. The communication plate 302 is a plate-shaped member that is elongated along the Y axis and extends substantially parallel to the XY plane. The communication plate 302 is formed with a supply flow path RA1, a discharge flow path RA2, M coupling flow paths RK1, M coupling flow paths RK2, M communication flow paths RR1, M communication flow paths RR2, and M nozzle flow paths RN as a part of a flow path through which ink flows.

The supply flow path RA is located on the +X side of the communication plate 302 and extends in the Y direction. The discharge flow path RA2 is located on the −X side of the communication plate 302 and extends in the Y direction. At this time, the supply flow path RA1 and the discharge flow path RA2 are formed so as to be substantially line-symmetrical with the Z axis passing through the nozzle N as the axis of symmetry. The M coupling flow paths RK1 are located on the −X side of the supply flow path RA1 and are arranged side by side along the Y direction. The M communication flow paths RR1 are located on the −X side of the M coupling flow paths RK1 arranged side by side along the Y direction, and are arranged side by side along the Y direction. The M coupling flow paths RK2 are located on the +X side of the discharge flow path RA2 and on the −X side of the M communication flow paths RR1 arranged side by side along the Y direction, and are arranged side by side along the Y direction. The M communication flow paths RR2 are located on the +X side of the M coupling flow paths RK2 arranged side by side along the Y direction and on the −X side of the M communication flow paths RR1 arranged side by side along the Y direction, and are arranged side by side along the Y direction. At this time, the coupling flow path RK1 and the coupling flow path RK2 are formed so as to be substantially line-symmetrical with the Z axis passing through the nozzle N as the axis of symmetry, and the communication flow path RR1 and the communication flow path RR2 are formed so as to be substantially line-symmetrical with the Z axis passing through the nozzle N as the axis of symmetry. The nozzle flow path RN communicates between the communication flow path RR1 and the communication flow path RR2, corresponding to the common nozzle N. When the communication plate 302 is viewed from the Z direction, the nozzle substrate 360 is fixed to the communication plate 302 so that the nozzle N is located at a substantially center of the nozzle flow path RN in the X direction.

The pressure chamber substrate 303 is located on the −Z side of the communication plate 302 and is fixed to the communication plate 302. The pressure chamber substrate 303 is a plate-shaped member that is elongated in the Y axis direction and extends substantially parallel to the XY plane. The pressure chamber substrate 303 is formed with M pressure chambers CB1 and M pressure chambers CB2 as a part of a flow path through which ink flows. At this time, the pressure chambers CB1 and the pressure chambers CB2 are formed so as to be substantially line-symmetrical with the Z axis passing through the nozzle N as the axis of symmetry.

The M pressure chambers CB1 correspond one-to-one with the M nozzles N and are arranged side by side along the Y axis. Each of the M pressure chambers CB1 communicates with the coupling flow path RK1 and the communication flow path RR1 corresponding to the common nozzle N. Specifically, when the pressure chamber CB1 is viewed from a direction along the Z axis, the end portion on the +X side communicates with the coupling flow path RK1 and the end portion on the −X side communicates with the communication flow path RR1. That is, the pressure chamber CB1 communicates between the coupling flow path RK1 and the communication flow path RR1 corresponding to the common nozzle N.

Similarly, the M pressure chambers CB2 correspond one-to-one with the M nozzles N, are located on the −X side of the M pressure chambers CB1 arranged side by side along the Y axis, and are arranged side by side along the Y axis. Each of the M pressure chambers CB2 communicates between the coupling flow path RK2 and the communication flow path RR2 corresponding to the common nozzle N. Specifically, when the pressure chamber CB2 is viewed from the direction along the Z axis, the end portion on the −X side communicates with the coupling flow path RK2 and the end portion on the +X side communicates with the communication flow path RR2. That is, the pressure chamber CB2 communicates between the coupling flow path RK2 and the communication flow path RR2 corresponding to the common nozzle N.

The vibration plate 304 is located on the −Z side of the pressure chamber substrate 303 and is fixed to the pressure chamber substrate 303 so as to close the pressure chambers CB1 and CB2. The vibration plate 304 is a plate-shaped member that is elongated in the Y direction, extends substantially parallel to the XY plane and is a member that can vibrate elastically. M piezoelectric elements 60a and M piezoelectric elements 60b are arranged side by side on the −Z side of the vibration plate 304. The M piezoelectric elements 60a are arranged side by side along the Y axis on the −Z side of the vibration plate 304. Further, the M piezoelectric elements 60b are arranged side by side along the Y axis on the −Z side of the vibration plate 304 and on the −X side of the M piezoelectric elements 60a arranged side by side along the Y axis. That is, on the −Z side of the vibration plate 304, a row of M piezoelectric elements 60a and a row of M piezoelectric elements 60b are arranged side by side.

The storage chamber formation substrate 305 is located on the −Z side of the communication plate 302. The storage chamber formation substrate 305 is a member that is elongated in the Y direction and includes an opening 350. The storage chamber formation substrate 305 is fixed to the communication plate 302 so that the pressure chamber substrate 303, the vibration plate 304, and a wiring substrate 308 are located inside the opening 350. Further, the storage chamber formation substrate 305 includes a supply flow path RB1, a discharge flow path RB2, a supply port 351, and a discharge port 352. The supply flow path RB1 communicates with the supply flow path RA1. The discharge flow path RB2 communicates with the discharge flow path RA2. The supply port 351 communicates with the supply flow path RB1. The discharge port 352 communicates with the discharge flow path RB2.

The ink stored in the liquid container 3 is supplied to the supply port 351 by the operation of the circulation unit 6. As a result, the ink is supplied to the head chip 22. The ink supplied to the head chip 22 flows inside the head chip 22 by the operation of the circulation unit 6 and is collected via the discharge port 352. That is, the ink supplied to the head chip 22 is recirculated by the operation of the circulation unit 6.

The flexible substrate 24 is electrically coupled to the vibration plate 304 on a surface on the −Z side of the vibration plate 304, on the −X side of the row of the M piezoelectric elements 60a and on the +X side of the row of the M piezoelectric elements 60b. That is, the flexible substrate 24 is electrically coupled to the vibration plate 304 between the row of the M piezoelectric elements 60a and the row of the M piezoelectric elements 60b provided on the vibration plate 304. At this time, it is preferable that the flexible substrate 24 is electrically coupled to the vibration plate 304 so that a distance between the flexible substrate 24 and the row of M piezoelectric elements 60a, and a distance between the flexible substrate 24 and the row of M piezoelectric elements 60b are substantially equal to each other.

An integrated circuit 201 is COF-mounted on the flexible substrate 24. The drive signal selection circuit 200 described above is mounted on the integrated circuit 201. The clock signal SCK, the latch signal LAT, the change signal CH, the inspection timing signal TSIG, the print data signal SI, the drive signal COM, and the reference voltage signal VBS propagate through the flexible substrate 24. Then, the clock signal SCK, the latch signal LAT, the change signal CH, the inspection timing signal TSIG, the print data signal SI, and the drive signal COM among the clock signal SCK, the latch signal LAT, the change signal CH, the inspection timing signal TSIG, the print data signal SI, the drive signal COM, and the reference voltage signal VBS that propagate through the flexible substrate 24 are input to the integrated circuit 201. The integrated circuit 201 generates the drive voltage signal Vin corresponding to each of the plurality of ejection sections 600 by selecting or not selecting the signal waveform of the drive signal COM based on the input clock signal SCK, latch signal LAT, change signal CH, inspection timing signal TSIG, and print data signal SI. The drive voltage signal Vin generated by the integrated circuit 201 propagates through the flexible substrate 24, and then the drive voltage signal Vin1 as the drive voltage signal Vin is supplied to the piezoelectric element 60a included in the corresponding ejection section 600, and the drive voltage signal Vin2 as the drive voltage signal Vin is supplied to the piezoelectric element 60b included in the corresponding ejection section 600. As a result, each of the M piezoelectric elements 60a and 60b is driven to be displaced along the Z axis. Then, the vibration plate 304 provided with the piezoelectric elements 60a and 60b is displaced along the Z axis by driving the piezoelectric elements 60a and 60b. The volume of the pressure chambers CB1 and CB2 changes due to the displacement of the vibration plate 304, and the internal pressures of the pressure chambers CB1 and CB2 change according to the volume changes of the pressure chambers CB1 and CB2. Then, ink is ejected from the nozzle N by the change in the internal pressure of the pressure chambers CB1 and CB2.

In addition, the compliance sheets 361 and 362 are located on the +Z side of the communication plate 302. The compliance sheet 361 closes the supply flow path RA1 and the coupling flow path RK1 formed at the communication plate 302. The compliance sheet 361 is formed to include an elastic material. As a result, pressure fluctuation generated in the supply flow path RA1 and the coupling flow path RK1 according to the change in the internal pressures of the pressure chambers CB1 and CB2 is absorbed. In addition, the compliance sheet 362 closes the discharge flow path RA2 and the coupling flow path RK2 formed at the communication plate 302. The compliance sheet 362 is formed to include an elastic material. As a result, pressure fluctuation generated in the discharge flow path RA2 and the coupling flow path RK2 according to the change in the internal pressures of the pressure chambers CB1 and CB2 is absorbed.

Here, in the print head 21, a configuration including the piezoelectric elements 60a and 60b, the pressure chambers CB1 and CB2, the communication flow paths RR1 and RR2, and the nozzles N included in the head chip 22 corresponds to the ejection section 600 described above.

Further, after the internal pressures of the pressure chambers CB1 and CB2 change, residual vibration corresponding to a state of the ink stored in the ejection section 600 is generated in the ejection section 600. Due to the residual vibration generated in the ejection section 600, the internal pressures and the volumes of the pressure chambers CB1 and CB2 change, and the vibration plate 304 is displaced. As a result, the piezoelectric elements 60a and 60b provided on the vibration plate 304 are deformed. Therefore, reverse electromotive force corresponding to the deformation of the piezoelectric element 60a is generated between both terminals of the piezoelectric element 60a, and reverse electromotive force corresponding to the deformation of the piezoelectric element 60b is generated between both terminals of the piezoelectric element 60b. The reverse electromotive force generated in the piezoelectric element 60a propagates through the flexible substrate 24 as the residual vibration signal Vout1, and the reverse electromotive force generated in the piezoelectric element 60b propagates through the flexible substrate 24 as the residual vibration signal Vout2. At this time, in the flexible substrate 24, wiring through which the residual vibration signal Vout1 propagates and wiring through which the residual vibration signal Vout2 propagates are electrically coupled to each other, and thus the residual vibration signal Vout1 and the residual vibration signal Vout2 are combined in the flexible substrate 24. The signal obtained by combining the residual vibration signal Vout1 and the residual vibration signal Vout2 is input to the integrated circuit 201 on which the drive signal selection circuit 200 is mounted as the residual vibration signal Vout.

The drive signal selection circuit 200 mounted on the integrated circuit 201 acquires the residual vibration signal Vout input from the ejection section 600 defined by the print data signal SI at a timing defined by the latch signal LAT, the change signal CH, and the inspection timing signal TSIG. Then, the drive signal selection circuit 200 outputs the acquired residual vibration signal Vout as the acquisition residual vibration signal NVT after shaping the signal waveform of the acquired residual vibration signal Vout.

As described above, the ejection section 600 included in the print head 21 of the present embodiment, which ejects ink to the medium P, includes the nozzle N that ejects the ink, the pressure chamber CB1 that communicates with the nozzle N and stores the ink, the pressure chamber CB2 that communicates with the nozzle N and stores the ink, the piezoelectric element 60a that detects the residual vibration generated in the pressure chamber CB1 and outputs the residual vibration as the residual vibration signal Vout1, and the piezoelectric element 60b that detects the residual vibration generated in the pressure chamber CB2 and outputs the residual vibration as the residual vibration signal Vout2, and outputs the composite wave of the residual vibration signal Vout1 and the residual vibration signal Vout2 as the residual vibration signal Vout.

Here, in the print head 21 of the present embodiment, the description will be made on the assumption that an element that generates the residual vibration in the pressure chamber CB1 and an element that detects the residual vibration generated in the pressure chamber CB1 are both the piezoelectric element 60a, and an element that generates the residual vibration in the pressure chamber CB2 and an element that detects the residual vibration generated in the pressure chamber CB2 are both the piezoelectric element 60b. However, the element that generates the residual vibration in the pressure chamber CB1 and the element that detects the residual vibration generated in the pressure chamber CB1 may be different elements, and the element that generates the residual vibration in the pressure chamber CB2 and the element that detects the residual vibration generated in the pressure chamber CB2 may be different elements.

However, as described in the present embodiment, it is preferable that the piezoelectric element 60a generates the residual vibration in the pressure chamber CB1 and detects the residual vibration generated in the pressure chamber CB1, and the piezoelectric element 60b generates the residual vibration in the pressure chamber CB2, and detects the residual vibration generated in the pressure chamber CB2. That is, it is preferable that the piezoelectric element 60a outputs the residual vibration signal Vout1 corresponding to the residual vibration generated according to the volume change of the pressure chamber CB1, and is driven corresponding to the drive voltage signal Vin corresponding to the drive signal COM, and the volume of the pressure chamber CB1 changes by driving the piezoelectric element 60a, and it is preferable that the piezoelectric element 60b outputs the residual vibration signal Vout2 corresponding to the residual vibration generated according to the volume change of the pressure chamber CB2, and is driven corresponding to the drive voltage signal Vin corresponding to the drive signal COM, and the volume of the pressure chamber CB2 changes by driving the piezoelectric element 60b. As a result, the number of piezoelectric elements 60a and 60b included in the print head 21 can be reduced, and the size of the print head 21 can be reduced.

### 4. Residual Vibration Acquisition Circuit

Next, a configuration and an operation of the residual vibration acquisition circuit 300 will be described. As described above, the residual vibration acquisition circuit 300 determines the state of the corresponding ejection section 600 based on the input acquisition residual vibration signal NVT, and outputs the state signals aDS and dDS according to the determination result. Here, in describing the configuration and the operation of the residual vibration acquisition circuit 300, a relationship between the acquisition residual vibration signal NVT input to the residual vibration acquisition circuit 300 and the residual vibration generated in the ejection section 600 and the state of the ejection section 600 will be described.

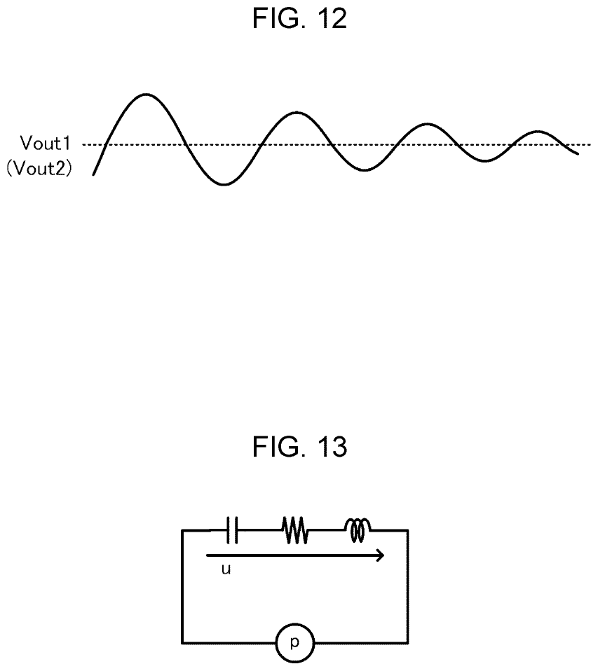

FIG. 12 is a diagram illustrating an example of the residual vibration signals Vout1 and Vout2. As illustrated in FIG. 12, the signal waveforms of the residual vibration signals Vout1 and Vout2 are attenuation vibration waveforms in which a voltage amplitude decreases with the passage of time corresponding to attenuation vibration generated in the vibration plate 304 due to the change in the internal pressure of the pressure chambers CB1 and CB2. Waveform information such as an amplitude, an attenuation rate, and a frequency of the attenuation vibration waveforms of the residual vibration signals Vout1 and Vout2 changes depending on the state of the ink stored in the pressure chambers CB1 and CB2 and the state of the ink flowing through the communication flow path RR1 and the nozzle flow path RN.

Here, a relationship between the waveform information of the residual vibration signals Vout1 and Vout2, the state of the ink stored in the pressure chambers CB1 and CB2, and the state of the ink flowing through the communication flow paths RR1 and RR2 and the nozzle flow path RN will be described using a calculation model. FIG. 13 is a diagram illustrating an example of the calculation model of a simple harmonic motion assuming the residual vibration generated in the pressure chamber CB1, the pressure chamber CB2, or the vibration plate 304. As described above, the piezoelectric elements 60a and 60b are displaced by being supplied with the corresponding drive voltage signals Vin1 and Vin2, and the vibration plate 304 is also displaced with the displacement of the piezoelectric elements 60a and 60b. As a result, the volume of the corresponding pressure chambers CB1 and CB2 changes with the displacement of the vibration plate 304. At this time, a part of the ink filled in the pressure chambers CB1 and CB2 is ejected from the nozzles N according to the pressure generated inside the pressure chambers CB1 and CB2.

In the series of operations of ejecting the ink from the nozzle N, the vibration plate 304 freely vibrates at a natural vibration frequency determined by a flow path resistance r based on a shape of the flow path through which the ink flows, the viscosity of the ink, and the like, an inertance m due to a liquid weight in the flow path, and the compliance C of the vibration plate 304, and the piezoelectric elements 60a and 60b are displaced according to the free vibration generated in the vibration plate 304. Further, the piezoelectric element 60a outputs the reverse electromotive force corresponding to the displacement as the residual vibration signal Vout1, and the piezoelectric element 60b outputs the reverse electromotive force corresponding to the displacement as the residual vibration signal Vout2.

The calculation model of the residual vibration generated in the vibration plate 304 can be represented by using the pressure p, the inertance m, the compliance C, and the flow path resistance r. By calculating a step response of a volume speed u when the pressure p is applied to the circuit illustrated in FIG. 13, the following Equations (1) to (3) can be obtained.

$$u = \frac{p}{ω \cdot m} {e}^{- a \cdot t} \cdot sin ωt \qquad ( 1 )$$

$$ω = \sqrt{\frac{1}{m \cdot Cm} - {a}^{2}} \qquad ( 2 )$$

$$a = \frac{r}{2 m} \qquad ( 3 )$$

For example, when the viscosity of the ink stored in the pressure chambers CB1 and CB2, the ink flowing through the communication flow paths RR1 and RR2 and the nozzle flow path RN, and the ink in the vicinity of the nozzle N, and the like is increased, the flow path resistance r is increased. At this time, according to the Equations (1) to (3), the frequency generated in the vibration plate 304 changes, and the attenuation rate of the attenuation vibration increases. Therefore, when the stored ink has an abnormal thickening, the frequency of the corresponding residual vibration signals Vout1 and Vout2 changes and the attenuation rate of the amplitude increases. That is, when the viscosity of the ink stored in the pressure chambers CB1 and CB2 increases and the thickening ratio increases, the frequency, the amplitude, and the attenuation rate of the residual vibration signals Vout1 and Vout2 change.

In addition, for example, when air bubbles are mixed in the pressure chambers CB1 and CB2, the communication flow paths RR1 and RR2, the nozzle flow path RN, and the nozzle N, the inertance m corresponding to the weight of the stored ink is reduced by the amount of the mixed air bubbles. At this time, according to the Equations (1) to (3), an angular velocity w increases, a vibration cycle of the residual vibration generated in the vibration plate 304 becomes shorter, and as a result, a vibration frequency of the residual vibration signals Vout1 and Vout2 becomes higher. That is, when air bubbles are mixed in the pressure chambers CB1 and CB2, the communication flow paths RR1 and RR2, and the nozzle flow path RN, the vibration frequency of the residual vibration signals Vout1 and Vout2 becomes higher.

As described above, when the pressure chamber CB1, the communication flow path RR1, the nozzle flow path RN, or the like have the abnormal thickening in which the viscosity of the ink increases or the abnormal mixing of air bubbles in which air bubbles are mixed, the waveform information such as the amplitude and the frequency of the residual vibration signal Vout1 changes. Similarly, when the pressure chamber CB2, the communication flow path RR2, the nozzle flow path RN, or the like have the abnormal thickening or the abnormal mixing of air bubbles, the waveform information such as the amplitude and the frequency of the residual vibration signal Vout2 changes. Therefore, when the state of the ejection section 600 is abnormal, the waveform information of the residual vibration signal Vout, which is a composite wave of the residual vibration signal Vout1 and the residual vibration signal Vout2, also changes.

The waveform shaping circuit 240 removes noise from the composite wave of the residual vibration signal Vout1 and the residual vibration signal Vout2, and amplifies the composite wave to shape the signal waveform. Therefore, the waveform information of the acquisition residual vibration signal NVT input to the residual vibration acquisition circuit 300 includes information corresponding to the waveform information of the residual vibration signal Vout1 and the waveform information of the residual vibration signal Vout2. That is, the waveform information of the acquisition residual vibration signal NVT changes with the change of the waveform information of the residual vibration signals Vout1 and Vout2. The residual vibration acquisition circuit 300 determines whether or not the waveform information such as the amplitude and the frequency of the residual vibration signals Vout1 and Vout2 is normal by acquiring the waveform information such as the amplitude and the frequency of the acquisition residual vibration signal NVT, and thus determines the state of the ejection section 600 to be inspected.

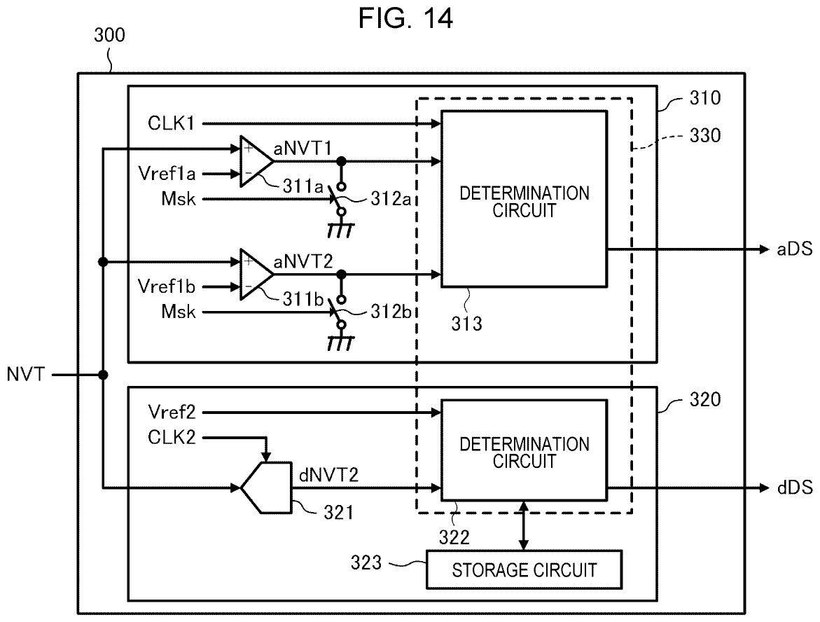

FIG. 14 is a diagram illustrating the configuration of the residual vibration acquisition circuit 300. As illustrated in FIG. 14, the residual vibration acquisition circuit 300 includes an analog acquisition circuit 310 and a digital acquisition circuit 320.

The analog acquisition circuit 310 includes comparators 311a and 311b, switches 312a and 312b, and a determination circuit 313, and generates and outputs the state signal aDS corresponding to the acquisition residual vibration signal NVT.

The acquisition residual vibration signal NVT is input to a +side input terminal of the comparator 311a. A reference voltage Vrefla is input to a −side input terminal. The comparator 311a compares a voltage value of the acquisition residual vibration signal NVT input to the +side input terminal with a voltage value of the reference voltage Vrefla input to the −side input terminal, generates a comparison result signal aNVT1 in which a logic level is switched according to the comparison result, and outputs the comparison result signal aNVT1 to the determination circuit 313. Specifically, the comparator 311a generates the comparison result signal aNVT1 that becomes an H level when the voltage value of the acquisition residual vibration signal NVT is greater than the voltage value of the reference voltage Vrefla, and becomes an L level when the voltage value of the acquisition residual vibration signal NVT is smaller than the voltage value of the reference voltage Vrefla, and outputs the comparison result signal aNVT1 to the determination circuit 313.

The acquisition residual vibration signal NVT is input to a +side input terminal of the comparator 311b. A reference voltage Vref1b is input to a −side input terminal. The comparator 311b compares a voltage value of the acquisition residual vibration signal NVT input to the +side input terminal with a voltage value of the reference voltage Vref1b input to the −side input terminal, generates a comparison result signal aNVT2 in which a logic level is switched according to the comparison result, and outputs the comparison result signal aNVT2 to the determination circuit 313. Specifically, the comparator 311b generates the comparison result signal aNVT2 that becomes an H level when the voltage value of the acquisition residual vibration signal NVT is greater than the voltage value of the reference voltage Vref1b, and becomes an L level when the voltage value of the acquisition residual vibration signal NVT is smaller than the voltage value of the reference voltage Vref1b, and outputs the comparison result signal aNVT2 to the determination circuit 313.

Here, in the following description, the description will be made on the assumption that the voltage value of the reference voltage Vref1b is greater than the voltage value of the reference voltage Vrefla.

One end of the switch 312a is electrically coupled to wiring through which the comparison result signal aNVT1 propagates, a ground potential is supplied to the other end, and a mask signal Msk is input to a control end. A conduction state between one end and the other end of the switch 312a is switched according to the mask signal Msk input to the control end. For example, when the mask signal Msk of the L level is input to the control end of the switch 312a, the switch 312a is controlled to be non-conductive between one end and the other end. As a result, the comparison result signal aNVT1 output by the comparator 311a is input to the determination circuit 313. In addition, for example, when the mask signal Msk of the H level is input to the control end of the switch 312a, the switch 312a is controlled to be conductive between one end and the other end. At this time, the wiring through which the comparison result signal aNVT1 propagates is controlled to the ground potential. Therefore, the comparison result signal aNVT1 output by the comparator 311a is not input to the determination circuit 313, and a signal of the ground potential is input to the determination circuit 313.

One end of the switch 312b is electrically coupled to wiring through which the comparison result signal aNVT2 propagates, a ground potential is supplied to the other end, and the mask signal Msk is input to a control end. A conduction state between one end and the other end of the switch 312b is switched according to the mask signal Msk input to the control end. For example, when the mask signal Msk of the L level is input to the control end of the switch 312b, the switch 312b is controlled to be non-conductive between one end and the other end. As a result, the comparison result signal aNVT2 output by the comparator 311b is input to the determination circuit 313. In addition, for example, when the mask signal Msk of the H level is input to the control end of the switch 312b, the switch 312b is controlled to be conductive between one end and the other end. At this time, the wiring through which the comparison result signal aNVT2 propagates is controlled to the ground potential. Therefore, the comparison result signal aNVT2 output by the comparator 311b is not input to the determination circuit 313, and a signal of the ground potential is input to the determination circuit 313.

That is, the switches 312a and 312b switch whether or not to input the comparison result signals aNVT1 and aNVT2 to the determination circuit 313 according to the logic level of the mask signal Msk. As the switches 312a and 312b, for example, an N-channel type MOS transistor can be used. Here, the mask signal Msk may be, for example, a signal output by the control circuit 100, or may be a signal output by a signal generation circuit (not illustrated) included in the residual vibration acquisition circuit 300. A relationship between an operation of the switches 312a and 312b and the logic level of the mask signal Msk is not limited to the above-described form. For example, in the switches 312a and 312b, one end and the other end may be conductive during the period in which the mask signal Msk is at the L level, and one end and the other end may be non-conductive during the period in which the mask signal Msk is at the H level.

The comparison result signal aNVT1 output by the comparator 311a, the comparison result signal aNVT2 output by the comparator 311b, and a clock signal CLK1 output by a clock circuit (not illustrated) are input to the determination circuit 313. The determination circuit 313 measures the length of the period in which the logic level of the comparison result signals aNVT1 and aNVT2 changes from the L level to the H level and becomes the L level, and the period in which the logic level of the comparison result signals aNVT1 and aNVT2 changes from the H level to the L level and becomes the H level, based on the number of clocks of the clock signal CLK1, and determines the state of the ejection section 600 based on the measurement result.

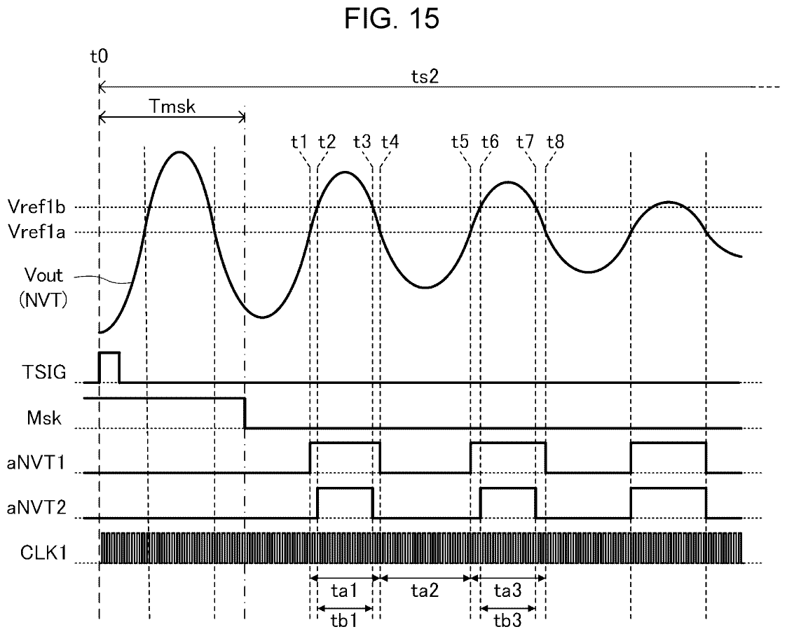

FIG. 15 is a diagram for describing an operation of the analog acquisition circuit 310. As illustrated in FIG. 15, at time to when the inspection timing signal TSIG rises, the period ts2 described above in which the drive signal selection circuit 200 acquires the residual vibration signal Vout corresponding to the residual vibration generated in the ejection section 600 to be inspected starts. That is, at time to, the acquisition residual vibration signal NVT is input to the residual vibration acquisition circuit 300.

In addition, at time to, the mask signal Msk of the H level is input to the analog acquisition circuit 310. At this time, the comparator 311a compares the voltage value of the input acquisition residual vibration signal NVT with the voltage value of the reference voltage Vrefla, and outputs the comparison result signal aNVT1 according to the comparison result, and the comparator 311b compares the voltage value of the input acquisition residual vibration signal NVT with the voltage value of the reference voltage Vref1b, and outputs the comparison result signal aNVT2 according to the comparison result, but a constant signal at the L level is input to the determination circuit 313.

The mask signal Msk becomes the H level only for a predetermined period Tmsk from time to when the supply of the acquisition residual vibration signal NVT to the residual vibration acquisition circuit 300 is started, and becomes the L level after the predetermined period Tmsk elapses. That is, after the time to, the acquisition of the acquisition residual vibration signal NVT by the analog acquisition circuit 310 is stopped only for the period Tmsk. As a result, a noise component, which is superimposed immediately after the residual vibration is generated in the ejection section 600 to be inspected, can be excluded, and an accuracy of the state determination of the ejection section 600 can be improved.

When the predetermined period Tmsk elapses from the time to at which the inspection timing signal TSIG rises and the logic level of the mask signal Msk is switched from the H level to the L level, the comparison result signal aNVT1 output by the comparator 311a and the comparison result signal aNVT2 output by the comparator 311b are input to the determination circuit 313.

The determination circuit 313 measures the length of a period ta1 from time t1 when the logic level of the comparison result signal aNVT1 is switched from the L level to the H level to time t4 when the logic level of the comparison result signal aNVT1 is switched from the H level to the L level, and measures the length of a period tb1 from time t2 when the logic level of the comparison result signal aNVT2 is switched from the L level to the H level to time t3 when the logic level of the comparison result signal aNVT2 is switched from the H level to the L level, based on the clock signal CLK. In addition, the determination circuit 313 measures the length of a period ta2 from the time t4 when the logic level of the comparison result signal aNVT1 is switched from the H level to the L level to time t5 when the logic level of the comparison result signal aNVT1 is switched from the L level to the H level after the period ta1, further measures the length of a period ta3 from the time t5 when the logic level of the comparison result signal aNVT1 is switched from the L level to the H level to time t8 when the logic level of the comparison result signal aNVT1 is switched from the H level to the L level after the period ta2, and measures the length of a period tb3 from time t6 when the logic level of the comparison result signal aNVT2 is switched from the L level to the H level to time t7 when the logic level of the comparison result signal aNVT2 is switched from the H level to the L level, based on the clock signal CLK.

The determination circuit 313 calculates the amplitude of the acquisition residual vibration signal NVT based on a ratio of the length of the period tb1 to the length of the period ta1, and calculates the frequency of the acquisition residual vibration signal NVT from the length of the period ta1 and the length of the period ta2. In addition, the attenuation rate of the amplitude of the acquisition residual vibration signal NVT is calculated from the amplitude of the acquisition residual vibration signal NVT calculated based on the ratio of the length of the period tb1 to the length of the period ta1 and the amplitude of the acquisition residual vibration signal NVT calculated based on the ratio of the length of the period tb3 to the length of the period ta3. That is, the determination circuit 313 calculates the waveform information of the acquisition residual vibration signal NVT from the periods ta1, ta2, ta3, tb1, and tb3.

Then, the determination circuit 313 determines whether or not the ejection section 600 to be inspected is normal based on whether or not each of the calculated waveform information is within a predetermined range. Thereafter, the determination circuit 313 generates the state signal aDS including information on the determination result and outputs the state signal aDS to the control circuit 100. Here, the determination circuit 313 may determine whether or not the ejection section 600 to be inspected is normal based on at least one of the frequency, the amplitude, and the attenuation rate of the amplitude of the acquisition residual vibration signal NVT. That is, the determination circuit 313 may determine the state of the ejection section 600 based on at least one of the time during which the voltage value of the acquisition residual vibration signal NVT exceeds the voltage values of the reference voltages Vrefla and Vref1b and the time during which the voltage value of the acquisition residual vibration signal NVT falls below the voltage values of the reference voltages Vrefla and Vref1b.

Returning to FIG. 14, the digital acquisition circuit 320 includes an A/D conversion circuit 321, a determination circuit 322, and a storage circuit 323, and generates and outputs the state signal dDS corresponding to the acquisition residual vibration signal NVT.

A clock signal CLK2 and the acquisition residual vibration signal NVT are input to the A/D conversion circuit 321. The A/D conversion circuit 321 sequentially converts the voltage value of the input acquisition residual vibration signal NVT into a digital signal in synchronization with the clock signal CLK2, acquires the converted voltage value as a detection voltage dNVT, and outputs the detection voltage signal dNVT including the acquired detection voltage dnvt to the determination circuit 322. The determination circuit 322 sequentially acquires the detection voltage dnvt included in the detection voltage signal dNVT input in synchronization with the clock signal CLK2, and stores information corresponding to the acquired detection voltage dnvt in the storage circuit 323. In addition, the determination circuit 322 reads information corresponding to the detection voltage dnvt stored in synchronization with the clock signal CLK2 from the storage circuit 323 after the period ts2 elapses, in which the drive signal selection circuit 200 acquires the residual vibration signal Vout corresponding to the residual vibration generated in the ejection section 600 to be inspected. Then, the determination circuit 322 calculates the waveform information such as the amplitude and the frequency of the acquisition residual vibration signal NVT based on the information corresponding to the read detection voltage dnvt, and determines whether or not the amplitude, the frequency, and the like of the residual vibration generated in the ejection section 600 to be inspected are normal based on the calculated waveform information.

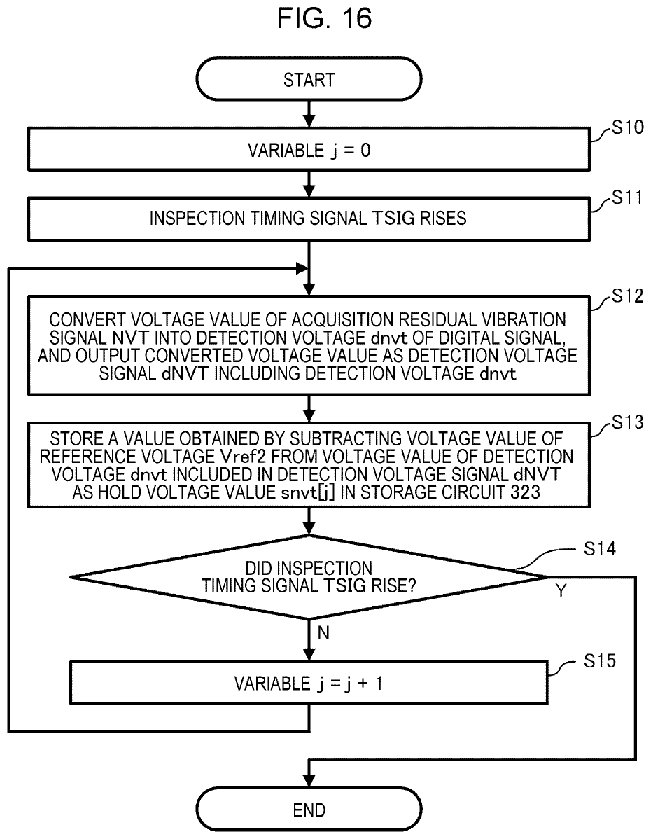

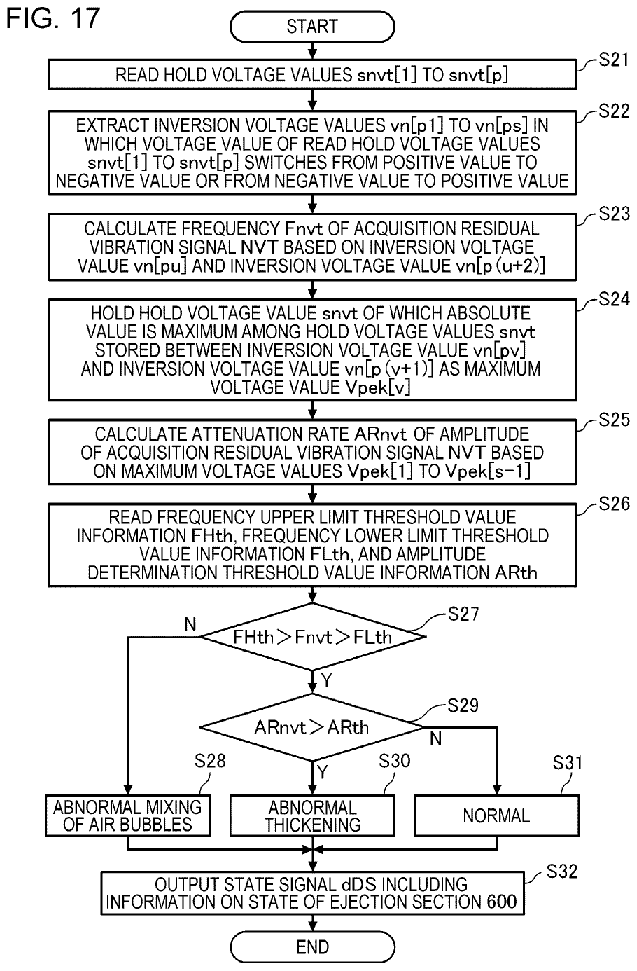

An example of an operation of the digital acquisition circuit 320 will be described. FIG. 16 is a diagram for describing an example of acquisition processing in which the digital acquisition circuit 320 acquires the acquisition residual vibration signal NVT, and FIG. 17 is a diagram for describing an example of determination processing of determining the state of the ejection section 600 based on information acquired in an acquisition operation.

As illustrated in FIG. 16, in executing the acquisition processing, the determination circuit 322 sets a variable j to “0” as initialization processing (step S10). After that, when the inspection timing signal TSIG rises (step S11), the drive signal selection circuit 200 controls the transfer gate 234c included in the selection circuit 230 corresponding to the ejection section 600 to be inspected, to be turned on. As a result, the drive signal selection circuit 200 acquires the residual vibration signal Vout corresponding to the residual vibration generated in the ejection section 600 to be inspected, and outputs the acquisition residual vibration signal NVT. Therefore, the acquisition residual vibration signal NVT is input to the digital acquisition circuit 320 of the residual vibration acquisition circuit 300.

The acquisition residual vibration signal NVT is input to the A/D conversion circuit 321 of the digital acquisition circuit 320. The A/D conversion circuit 321 converts the voltage value of the input acquisition residual vibration signal NVT into the detection voltage dnvt of the digital signal, and outputs the converted voltage value as the detection voltage signal dNVT including the detection voltage dnvt (step S12).

The detection voltage signal dNVT including the detection voltage dnvt output by the A/D conversion circuit 321 is input to the determination circuit 322. The determination circuit 322 stores a value obtained by subtracting the voltage value of the reference voltage Vref2 from the voltage value of the detection voltage dnvt included in the detection voltage signal dNVT as a hold voltage value snvt[j] in the storage circuit 323 (step S13). Thereafter, the determination circuit 322 determines whether or not the inspection timing signal TSIG rose (step S14). At this time, the determination circuit 322 may directly detect the inspection timing signal TSIG to determine whether or not the inspection timing signal TSIG rose, and may determine whether or not the inspection timing signal TSIG rose based on whether or not a predetermined period elapsed from the rise of the inspection timing signal TSIG that defines the start of the period ts2. When the determination circuit 322 determines that the inspection timing signal TSIG did not rise (N in step S14), the determination circuit 322 adds 1 to the variable j (step S15), and repeats the processing of steps S12 to S14 described above. Here, the voltage value of the reference voltage Vref2 is preferably, for example, a voltage value of a direct-current component superimposed on the acquisition residual vibration signal NVT.

That is, the A/D conversion circuit 321 sequentially converts the voltage value of the acquisition residual vibration signal NVT input in the period from the rise of the inspection timing signal TSIG to the next rise of the inspection timing signal TSIG, that is, during the period ts2, into a digital signal at a timing based on a sampling cycle defined by the clock signal CLK2, converts the voltage value into the detection voltage dnvt, which is the converted digital signal, and outputs the converted detection voltage dnvt to the determination circuit 322, and the determination circuit 322 sequentially stores the signal corresponding to the input detection voltage dnvt in the storage circuit 323 at a timing based on the clock signal CLK2.

Thereafter, when the determination circuit 322 determines that the inspection timing signal TSIG rose (Y in step S14), the drive signal selection circuit 200 controls the transfer gate 234c included in the selection circuit 230 corresponding to the ejection section 600 to be inspected, to be turned off, and the acquisition processing is completed.

Next, the determination processing of determining the state of the ejection section 600 to be inspected based on the hold voltage value snvt[j], which is information acquired in the above-described acquisition operation and is stored in the storage circuit 323 will be described. Here, in the example of the determination processing illustrated in FIG. 17, the description will be made on the assumption that, in the acquisition processing, the A/D conversion circuit 321 acquired p detection voltages dnvt from the acquisition residual vibration signal NVT. That is, the description will be made on the assumption that the hold voltage values snvt[1] to snvt[p] are stored in the storage circuit 323.

When the determination processing is started, the determination circuit 322 reads the hold voltage values snvt[1] to snvt[p] from the storage circuit 323 (step S21). The determination circuit 322 extracts the hold voltage value snvt at the timing when the voltage value switches from a positive value to a negative value or from a negative value to a positive value from the read hold voltage values snvt[1] to snvt[p]. Here, in the following description, the hold voltage value snvt at the timing when the voltage value is first changed from a positive value to a negative value or from a negative value to a positive value after the rise of the inspection timing signal TSIG is referred to as an inversion voltage value vn[p1], and the hold voltage value snvt at the timing when the voltage value is finally changed from a positive value to a negative value or from a negative value to a positive value after the rise of the inspection timing signal TSIG, that is, the hold voltage value snvt at the timing when the voltage value is changed from a positive value to a negative value or from a negative value to a positive value at the s-th timing is referred to as an inversion voltage value vn[ps]. That is, the determination circuit 322 extracts the inversion voltage values vn[p1] to vn[ps] at the timing at which the voltage value switches from a positive value to a negative value or from a negative value to a positive value from the read hold voltage values snvt[1] to snvt[p] (step S22).

Then, the determination circuit 322 calculates a frequency Fnvt of the acquisition residual vibration signal NVT based on the inversion voltage value vn[pu] (u is any of 1 to s−2) and the inversion voltage value vn[p (u+2)] among the extracted inversion voltage values vn[p1] to vn[ps] (step S23).

Specifically, the determination circuit 322 calculates the number of acquired hold voltage values snvt between the inversion voltage value vn[pu] and the inversion voltage value vn[p (u+2)]. The determination circuit 322 calculates the time from the inversion voltage value vn[pu] to the inversion voltage value vn[p (u+2)] from the number of calculated hold voltage values snvt and the sampling cycle of the A/D conversion circuit 321. Then, the determination circuit 322 calculates the frequency Fnvt of the acquisition residual vibration signal NVT based on the time from the calculated inversion voltage value vn[pu] to the inversion voltage value vn[p (u+2)].

In addition, the determination circuit 322 holds the hold voltage value snvt of which an absolute value is the maximum, among the hold voltage values snvt stored between the inversion voltage value vn[pv] (v is any of 1 to s−1) and the inversion voltage value vn[p (v+1)], as a maximum voltage value Vpek[v] (step S24). Specifically, the determination circuit 322 stores the hold voltage value snvt of which an absolute value is the maximum, among the hold voltage values snvt stored between the inversion voltage value vn[p1] and the inversion voltage value vn[p2], as a maximum voltage value Vpek[1], similarly holds the hold voltage value snvt of which an absolute value is the maximum, among the hold voltage values snvt held between the inversion voltage value vn[pv] and the inversion voltage value vn[p (v+1)], as the maximum voltage value Vpek[v], and holds the hold voltage value snvt of which an absolute value is the maximum, among the hold voltage values snvt stored between the inversion voltage value vn[p (s−1)] and the inversion voltage value vn[ps], as a maximum voltage value Vpek[s−1]. The maximum voltage value Vpek[v] held by the determination circuit 322 corresponds to the amplitude generated in the acquisition residual vibration signal NVT. Then, the determination circuit 322 calculates an attenuation rate ARnvt of the amplitude of the acquisition residual vibration signal NVT based on the maximum voltage values Vpek[1] to Vpek[s−1] corresponding to the amplitude generated in the acquisition residual vibration signal NVT (step S25).

Thereafter, the determination circuit 322 reads frequency upper limit threshold value information FHth, frequency lower limit threshold value information FLth, and amplitude determination threshold value information ARth from the storage circuit 323 (step S26). Here, the frequency upper limit threshold value information FHth, the frequency lower limit threshold value information FLth, and the amplitude determination threshold value information ARth can be set based on the frequency, the amplitude, and the attenuation rate of the residual vibration signal Vout, which is the composite wave of the residual vibration signals Vout1 and Vout2 output by the piezoelectric elements 60a and 60b when the pressure chambers CB1 and CB2 are normal.

The determination circuit 322 determines whether or not the calculated frequency Fnvt of the acquisition residual vibration signal NVT is between the frequency upper limit threshold value information FHth and the frequency lower limit threshold value information FLth. That is, the determination circuit 322 determines whether or not the frequency Fnvt is smaller than the frequency upper limit threshold value information FHth and the frequency Fnvt is greater than the frequency lower limit threshold value information FLth (step S27). Then, when the frequency Fnvt is equal to or more than the frequency upper limit threshold value information FHth or the frequency Fnvt is equal to or less than the frequency lower limit threshold value information FLth (N in step S27), that is, when the calculated frequency Fnvt of the acquisition residual vibration signal NVT is not between the frequency upper limit threshold value information FHth and the frequency lower limit threshold value information FLth, the determination circuit 322 determines that the abnormal mixing of air bubbles is generated in the ejection section 600 to be inspected (step S28), and outputs the state signal dDS including information that the abnormal mixing of air bubbles is generated in the ejection section 600 to be inspected (step S32).

In addition, when the frequency Fnvt is smaller than the frequency upper limit threshold value information FHth and the frequency Fnvt is greater than the frequency lower limit threshold value information FLth (Y in step S27), the determination circuit 322 determines whether or not the attenuation rate ARnvt of the amplitude of the acquisition residual vibration signal NVT is greater than the amplitude determination threshold value information ARth (step S29). Then, when the attenuation rate ARnvt of the amplitude of the acquisition residual vibration signal NVT is greater than the amplitude determination threshold value information ARth (Y in step S29), the determination circuit 322 determines that the abnormal thickening is generated in the ejection section 600 to be inspected (step S30), and outputs the state signal dDS including information that the abnormal thickening is generated in the ejection section 600 to be inspected (step S32). In addition, when the attenuation rate ARnvt of the amplitude of the acquisition residual vibration signal NVT is equal to or less than the amplitude determination threshold value information ARth (N in step S29), the determination circuit 322 determines that the ejection section 600 to be inspected is normal (step S31), and outputs the state signal dDS including the information that the ejection section 600 to be inspected is normal (step S32). Then, the determination circuit 322 outputs the state signal dDS, thus the state determination of the ejection section 600 based on the acquisition residual vibration signal NVT in the digital acquisition circuit 320 is ended.

That is, the determination circuit 322 determines the state of the ejection section 600 based on the cycle and the amplitude of the acquisition residual vibration signal NVT acquired based on the detection voltage signal dNVT including the detection voltage dnvt.

As described above, the residual vibration acquisition circuit 300 includes the comparators 311a and 311b that output the comparison result signals aNVT1 and aNVT2 in which the logic levels change according to the comparison result between the voltage value of the acquisition residual vibration signal NVT and the voltage values of the reference voltages Vrefla and Vref1b, the A/D conversion circuit 321 that outputs the detection voltage signal dNVT obtained by converting the acquisition residual vibration signal NVT into a digital signal, and the determination circuit 330 including the determination circuits 313 and 322 that determine the state of the ejection section 600, and the determination circuit 330 includes a mode in which the determination circuit 313 determines the state of the ejection section 600 according to the comparison result signals aNVT1 and aNVT2, and a mode in which the determination circuit 322 determines the state of the ejection section 600 according to the detection voltage signal dNVT.

As described above, when the state of the ejection section 600 to be inspected is determined by using the analog acquisition circuit 310, the time for determining whether or not the voltage value of the acquisition residual vibration signal NVT is equal to or more than a predetermined value is measured according to the number of clocks of the clock signal CLK1, and the determination is made based on the measurement result. Therefore, when the state of the ejection section 600 to be inspected is determined by using the analog acquisition circuit 310, there is an advantage that the state determination of the ejection section 600 to be inspected can be performed in a short time, but it is difficult to improve a waveform information acquisition accuracy of the acquisition residual vibration signal NVT, particularly the acquisition accuracy of the amplitude of the acquisition residual vibration signal NVT.

On the other hand, when the state of the ejection section 600 to be inspected is determined by using the digital acquisition circuit 320, the signal waveform of the acquisition residual vibration signal NVT is converted into a digital signal, and the determination is made based on the digital signal corresponding to the voltage value of the acquisition residual vibration signal NVT. Therefore, when the state of the ejection section 600 to be inspected is determined by using the digital acquisition circuit 320, there is an advantage that the waveform information of the acquisition residual vibration signal NVT can be acquired with high accuracy because the voltage value of the acquisition residual vibration signal NVT can be directly acquired. On the other hand, it is necessary to perform arithmetic processing for converting the signal waveform of the acquisition residual vibration signal NVT into a digital signal and calculating the waveform information from the digital signal corresponding to the voltage value of the acquisition residual vibration signal NVT. Therefore, it is difficult to execute the state determination of the ejection section 600 to be inspected in a short time.

In the liquid ejecting apparatus 1 of the present embodiment, the state determination of the ejection section 600 using the analog acquisition circuit 310 and the state determination of the ejection section 600 using the digital acquisition circuit 320 are appropriately switched and executed, so that the state determination of the ejection section 600 can be executed in a short time and with high accuracy.

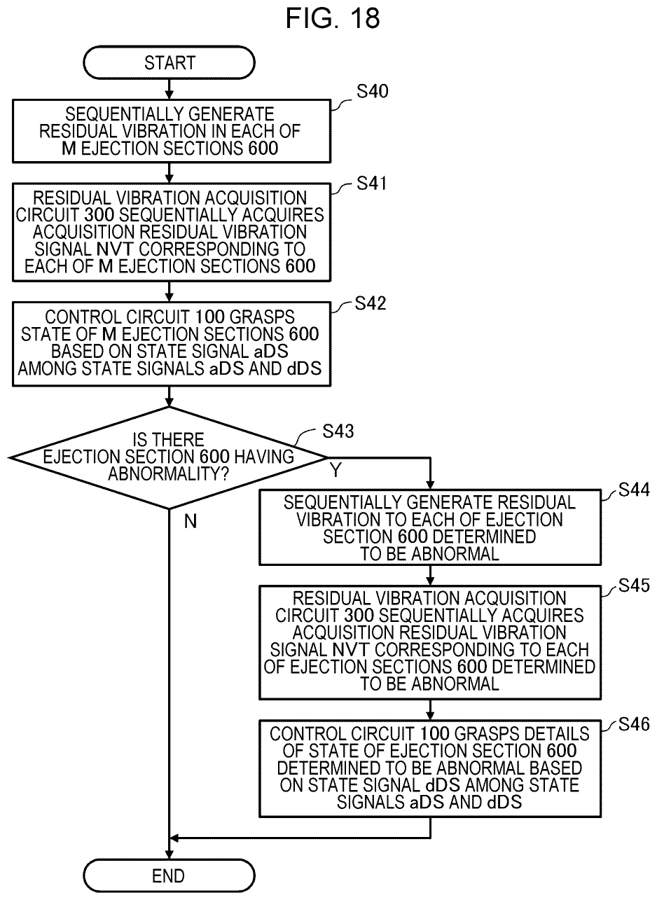

FIG. 18 is a diagram for describing a method of the state determination of the ejection section 600 in the liquid ejecting apparatus 1 of the present embodiment. When the state determination of the ejection section 600 is started, the control circuit 100 sequentially generates residual vibration in each of the M ejection sections 600 (step S40). As a result, the acquisition residual vibration signal NVT corresponding to the residual vibration generated in each of the M ejection sections 600 is input to the residual vibration acquisition circuit 300. That is, the residual vibration acquisition circuit 300 sequentially acquires the acquisition residual vibration signal NVT corresponding to each of the M ejection sections 600 (step S41), and outputs the state signals aDS and dDS corresponding to the acquired acquisition residual vibration signal NVT.

The control circuit 100 ascertains the state of each of the M ejection sections 600 based on the state signal aDS among the state signals aDS and dDS output by the residual vibration acquisition circuit 300 (step S42). That is, the determination result of the state of the ejection section 600 by the analog acquisition circuit 310 is acquired. At this time, when the state signal aDS corresponding to the state of the ejection section 600 to be inspected is input, the control circuit 100 outputs various signals for generating residual vibration in the next ejection section 600 to be inspected regardless of the input of the state signal dDS. Therefore, in the state detection of the M ejection sections 600, the possibility that the processing of the digital acquisition circuit 320 becomes a bottleneck is reduced. As a result, the time required for the state detection of the M ejection sections 600 is shortened.

The control circuit 100 determines whether or not there is the ejection section 600 having an abnormality based on the state signal aDS corresponding to each of the M ejection sections 600 (step S43). When the control circuit 100 determines that there is no ejection section 600 having the abnormality (N in step S43), the control circuit 100 ends the state determination of the ejection section 600. On the other hand, when the control circuit 100 determines that there is the ejection section 600 having the abnormality (Y in step S43), the control circuit 100 generates the residual vibration to the ejection section 600 determined to be abnormal based on the state signal aDS (step S44). As a result, the acquisition residual vibration signal NVT corresponding to the residual vibration generated in each of the ejection sections 600 determined to be abnormal based on the state signal aDS is input to the residual vibration acquisition circuit 300. That is, the residual vibration acquisition circuit 300 sequentially acquires the acquisition residual vibration signal NVT corresponding to each of the ejection sections 600 determined to be abnormal based on the state signal aDS (step S45), and outputs the state signals aDS and dDS corresponding to the acquired acquisition residual vibration signal NVT.

Then, the control circuit 100 ascertains the details of the state of the ejection section 600 determined to be abnormal based on the state signal dDS among the state signals aDS and dDS output by the residual vibration acquisition circuit 300 (step S46), and ends the state determination of the ejection section 600.

That is, in the liquid ejecting apparatus 1 of the present embodiment, when the determination circuit 313 determines that the ejection section 600 has an abnormality in steps S40 to S42 in the mode in which the determination circuit 313 determines the state of the ejection section 600 according to the comparison result signals aNVT1 and aNVT2, the liquid ejecting apparatus 1 executes steps S44 to S46 in the mode in which the determination circuit 322 determines the state of the ejection section 600 according to the detection voltage signal dNVT. On the other hand, when the determination circuit 313 determines that the ejection section 600 does not have the abnormality in steps S40 to S42 in the mode in which the determination circuit 313 determines the state of the ejection section 600 according to the comparison result signals aNVT1 and aNVT2, the liquid ejecting apparatus 1 does not execute the state determination of the ejection section 600 in the mode in which the determination circuit 322 determines the state of the ejection section 600 according to the detection voltage signal dNVT. As a result, the state determination of the ejection section 600 can be executed in a short time and with high accuracy.

The ejection unit 5 corresponds to a head unit, the transport unit 4 is an example of a transport section, the pressure chamber CB1 is an example of a first pressure chamber, the pressure chamber CB2 is an example of a second pressure chamber, the piezoelectric element 60a is an example of a first detection element, the piezoelectric element 60b is an example of a second detection element, at least one of the drive signal selection circuit 200 and the waveform shaping circuit 240 included in the drive signal selection circuit 200 is an example of a residual vibration detection circuit, the comparators 311a and 311b are examples of a comparison circuit and a first conversion circuit, the A/D conversion circuit 321 is an example of an A/D conversion circuit and a second conversion circuit, the determination circuit 330 is an example of a determination circuit, the determination circuit 313 included in the determination circuit 330 is an example of a first determination circuit, and the determination circuit 322 included in the determination circuit 330 is an example of a second determination circuit. In addition, the residual vibration signal Vout is an example of a residual vibration signal, the residual vibration signal Vout1 is an example of a first residual vibration signal, the residual vibration signal Vout2 is an example of a second residual vibration signal, the acquisition residual vibration signal NVT is an example of a residual vibration detection signal, the comparison result signals aNVT1 and aNVT2 are examples of comparison result signals, the detection voltage signal dNVT is an example of a detection voltage signal, and the reference voltages Vrefla and Vref1b are examples of reference voltage values. Further, the mode in which the determination circuit 313 included in the analog acquisition circuit 310 determines the state of the ejection section 600 according to the comparison result signals aNVT1 and aNVT2 is an example of a first determination mode, and the mode in which the determination circuit 322 included in the digital acquisition circuit 320 determines the state of the ejection section 600 according to the detection voltage signal dNVT is an example of a second determination mode.

### 5. Operational Effects

As described above, in the liquid ejecting apparatus 1 of the present embodiment, the determination circuit 330 that determines the state of the ejection section 600 includes the mode in which the state of the ejection section 600 is determined according to the comparison result signals aNVT1 and aNVT2 corresponding to the acquisition residual vibration signals NVT output by the comparators 311a and 311b, and the mode in which the state of the ejection section 600 is determined according to the detection voltage signal dNVT obtained by converting the acquisition residual vibration signal NVT output by the A/D conversion circuit 321 into a digital signal.

Here, in the mode in which the state of the ejection section 600 is determined according to the comparison result signals aNVT1 and aNVT2 corresponding to the acquisition residual vibration signals NVT output by the comparators 311a and 311b, since the state of the ejection section 600 can be determined according to the comparison result obtained by directly comparing the acquisition residual vibration signal NVT, the time required for the determination processing can be shortened, and as a result, the state determination of the ejection section 600 can be executed in a short time. On the other hand, in the mode in which the state of the ejection section 600 is determined according to the detection voltage signal dNVT obtained by converting the acquisition residual vibration signal NVT output by the A/D conversion circuit 321 into a digital signal, since the state of the ejection section 600 is determined according to the detection voltage signal dNVT obtained by converting the input acquisition residual vibration signal NVT into a digital signal, the acquisition accuracy of the waveform information of the acquisition residual vibration signal NVT is improved, and the determination accuracy of the ejection section 600 is improved.

In the liquid ejecting apparatus 1 of the present embodiment, the comparator 311a and 311b that have one residual vibration signal Vout and acquire the waveform information of the acquisition residual vibration signal NVT corresponding to the residual vibration signal Vout, and the A/D conversion circuit 321 are included. The determination circuit 330 switches between determining the state of the ejection section 600 according to the comparison result signals aNVT1 and aNVT2 output by the comparators 311a and 311b and determining the state of the ejection section 600 according to the detection voltage signal dNVT output by the A/D conversion circuit 321, for example, according to an operating environment such as the number of the ejection sections 600 to be inspected and a usage status of the liquid ejecting apparatus 1. Therefore, the shortening of the inspection time of the state of the ejection section 600 and the improvement of the determination accuracy of the state of the ejection section 600 can be optimally switched, and as a result, both the improvement of the determination accuracy of the state of the ejection section 600 and the shortening of the inspection time of the state of the ejection section 600 can be achieved.

In the liquid ejecting apparatus 1 of the present embodiment, when it is determined that the ejection section 600 has the abnormality in a mode in which the determination circuit 313 determines the state of the ejection section 600 according to the comparison result signals aNVT1 and aNVT2, the determination circuit 322 determines the state of the ejection section 600 according to the detection voltage signal dNVT, and when it is determined that the ejection section 600 does not have the abnormality in a mode in which the determination circuit 313 determines the state of the ejection section 600 according to the comparison result signals aNVT1 and aNVT2, the determination circuit 322 does not determine the state of the ejection section 600 according to the detection voltage signal dNVT. Therefore, only the state of the ejection section 600 that has the abnormality can be determined with high accuracy, and as a result, the state determination of all the M ejection sections 600 can be executed in a short time and with high accuracy.

In the liquid ejecting apparatus 1 of the present embodiment, the ejection section 600 includes the nozzle N that ejects the ink, the pressure chamber CB1 that communicates with the nozzle N and stores the ink, the pressure chamber CB2 that communicates with the nozzle N and stores the ink, the piezoelectric element 60a that detects the residual vibration generated in the pressure chamber CB1 and outputs the residual vibration as the residual vibration signal Vout1, and the piezoelectric element 60b that detects the residual vibration generated in the pressure chamber CB2 and outputs the residual vibration as the residual vibration signal Vout2. The composite wave of the residual vibration signal Vout1 and the residual vibration signal Vout2 is output as the residual vibration signal Vout. Therefore, even when the signal waveform of the residual vibration signal Vout, which is the composite wave, is complicated because at least one of the pressure chamber CB1 and the pressure chamber CB2 has an abnormality, the determination circuit 330 includes a mode of determining the state of the ejection section 600 according to the detection voltage signal dNVT obtained by converting the acquisition residual vibration signal NVT output by the A/D conversion circuit 321 into a digital signal. Therefore, the state of the ejection section 600 can be determined with high accuracy.

### 6. Modification Example

Here, in the present embodiment, the description was made on the assumption that the reverse electromotive force generated in the electrodes of the piezoelectric elements 60a and 60b to which the drive voltage signal Vin is supplied by the residual vibration generated in the ejection section 600 is acquired as the residual vibration signal Vout, but the reverse electromotive force generated in the electrodes of the piezoelectric elements 60a and 60b to which the reference voltage signal VBS is supplied by the residual vibration generated in the ejection section 600 may be acquired as the residual vibration signal Vout.

Hitherto, the embodiments and the modification examples were described. However, the present disclosure is not limited to the embodiments, and can be implemented in various aspects within the scope not departing from the concept of the present disclosure. For example, the embodiments described above can also be combined with each other as appropriate.

The present disclosure includes substantially the same configurations (for example, configurations having the same functions, methods, and results, or configurations having the same objects and effects) as the configurations described in the embodiments. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

The following contents are derived from the above-described embodiments.

According to an aspect, there is provided a liquid ejecting apparatus including a transport section that transports a medium, an ejection section that ejects liquid to the medium, a residual vibration detection circuit that acquires a residual vibration signal corresponding to residual vibration generated in the ejection section and outputs a residual vibration detection signal corresponding to the residual vibration signal, a first conversion circuit that includes a comparison circuit and outputs a comparison result signal in which a logic level changes according to a comparison result between a voltage value of the residual vibration detection signal and a reference voltage value, a second conversion circuit that includes an A/D conversion circuit and outputs a detection voltage signal obtained by converting the residual vibration detection signal into a digital signal, and a determination circuit that determines a state of the ejection section, in which the determination circuit includes a first determination mode in which the state of the ejection section is determined according to the comparison result signal, and a second determination mode in which the state of the ejection section is determined according to the detection voltage signal.

According to this liquid ejecting apparatus, the determination circuit that determines the state of the ejection section includes the first determination mode in which the state of the ejection section is determined according to the comparison result signal in which the logic level changes according to the comparison result of the voltage value of the residual vibration detection signal with the reference voltage value output by the first conversion circuit including the comparison circuit, and the second determination mode in which the state of the ejection section is determined according to the detection voltage signal obtained by converting the residual vibration detection signal into the digital signal output by the second conversion circuit including the A/D conversion circuit. Therefore, the detection of the state of the ejection section in a short time and the detection of the state of the ejection section with high accuracy can be optimally switched. As a result, it is possible to achieve both improvement in the determination accuracy of the state of the ejection section and shortening of the inspection time of the state of the ejection section.

In the aspect of the liquid ejecting apparatus, the determination circuit may determine the state of the ejection section in the second determination mode when it is determined that the ejection section has an abnormality in the first determination mode, and does not need to execute the determination of the state of the ejection section in the second determination mode when it is determined that the ejection section does not have the abnormality in the first determination mode.

According to this liquid ejecting apparatus, when it is determined that the ejection section has the abnormality in the first determination mode, the state of the ejection section is determined in the second determination mode, and when it is determined that the ejection section does not have the abnormality in the first determination mode, the determination of the state of the ejection section in the second determination mode is not executed. Therefore, only the state of the ejection section that has the abnormality can be determined with high accuracy, and the state determination of all the plurality of ejection sections can be executed in a short time and with high accuracy.

In the aspect of the liquid ejecting apparatus, the ejection section may include a nozzle that ejects the liquid, a first pressure chamber that communicates with the nozzle and in which the liquid is stored, a second pressure chamber that communicates with the nozzle and in which the liquid is stored, a first detection element that detects residual vibration generated in the first pressure chamber and outputs the residual vibration as a first residual vibration signal, and a second detection element that detects residual vibration generated in the second pressure chamber and outputs the residual vibration as a second residual vibration signal, and output a composite wave of the first residual vibration signal and the second residual vibration signal as the residual vibration signal.

According to this liquid ejecting apparatus, even when the signal waveform of the residual vibration signal, which is the composite wave, is complicated due to the generation of the abnormality in at least one of the first pressure chamber and the second pressure chamber, the state of the ejection section can be determined with high accuracy since the second determination mode of determining the state of the ejection section according to the detection voltage signal obtained by converting the residual vibration detection signal, which is output by the second conversion circuit including the A/D conversion circuit, into the digital signal is provided.

In the aspect of the liquid ejecting apparatus, in the first determination mode, the determination circuit may determine the state of the ejection section based on at least one of a time during which the voltage value of the residual vibration detection signal exceeds the reference voltage value and a time during which the voltage value of the residual vibration detection signal falls below the reference voltage value.

In the aspect of the liquid ejecting apparatus, in the second determination mode, the determination circuit may determine the state of the ejection section according to a cycle and an amplitude of the residual vibration detection signal acquired based on the detection voltage signal.

In the aspect of the liquid ejecting apparatus, the determination circuit may include a first determination circuit that determines the state of the ejection section in the first determination mode, and a second determination circuit that determines the state of the ejection section in the second determination mode.

According to another aspect, there is provided a head unit including an ejection section that ejects liquid to a medium, a residual vibration detection circuit that acquires a residual vibration signal corresponding to residual vibration generated in the ejection section and outputs a residual vibration detection signal corresponding to the residual vibration signal, a first conversion circuit that includes a comparison circuit and outputs a comparison result signal in which a logic level changes according to a comparison result between a voltage value of the residual vibration detection signal and a reference voltage value, a second conversion circuit that includes an A/D conversion circuit and outputs a detection voltage signal obtained by converting the residual vibration detection signal into a digital signal, and a determination circuit that determines a state of the ejection section, in which the determination circuit includes a first determination mode in which the state of the ejection section is determined according to the comparison result signal, and a second determination mode in which the state of the ejection section is determined according to the detection voltage signal.

According to this head unit, the determination circuit that determines the state of the ejection section includes the first determination mode in which the state of the ejection section is determined according to the comparison result signal in which the logic level changes according to the comparison result of the voltage value of the residual vibration detection signal and the reference voltage value output by the first conversion circuit including the comparison circuit, and the second determination mode in which the state of the ejection section is determined according to the detection voltage signal obtained by converting the residual vibration detection signal, which is output by the second conversion circuit including the A/D conversion circuit, into the digital signal. Therefore, the detection of the state of the ejection section in a short time and the detection of the state of the ejection section with high accuracy can be optimally switched. As a result, it is possible to achieve both improvement in the determination accuracy of the state of the ejection section and shortening of the inspection time of the state of the ejection section.

In the aspect of the head unit, the determination circuit may determine the state of the ejection section in the second determination mode when it is determined that the ejection section has an abnormality in the first determination mode, and does not need to execute the determination of the state of the ejection section in the second determination mode when it is determined that the ejection section does not have the abnormality in the first determination mode.

According to this head unit, when it is determined that the ejection section has the abnormality in the first determination mode, the state of the ejection section is determined in the second determination mode, and when it is determined that the ejection section does not have the abnormality in the first determination mode, the determination of the state of the ejection section in the second determination mode is not executed. Therefore, only the state of the ejection section that has the abnormality can be determined with high accuracy, and the state determination of all the plurality of ejection sections can be executed in a short time and with high accuracy.

In the aspect of the head unit, the ejection section may include a nozzle that ejects the liquid, a first pressure chamber that communicates with the nozzle and in which the liquid is stored, a second pressure chamber that communicates with the nozzle and in which the liquid is stored, a first detection element that detects residual vibration generated in the first pressure chamber and outputs the residual vibration as a first residual vibration signal, and a second detection element that detects residual vibration generated in the second pressure chamber and outputs the residual vibration as a second residual vibration signal, and output a composite wave of the first residual vibration signal and the second residual vibration signal as the residual vibration signal.

According to this head unit, even when the signal waveform of the residual vibration signal, which is the composite wave, is complicated due to the generation of the abnormality in at least one of the first pressure chamber and the second pressure chamber, the state of the ejection section can be determined with high accuracy since the second determination mode of determining the state of the ejection section according to the detection voltage signal obtained by converting the residual vibration detection signal, which is output by the second conversion circuit including the A/D conversion circuit, into the digital signal is provided.

In the aspect of the head unit, in the first determination mode, the determination circuit may determine the state of the ejection section based on at least one of a time during which the voltage value of the residual vibration detection signal exceeds the reference voltage value and a time during which the voltage value of the residual vibration detection signal falls below the reference voltage value.

In the head unit according to the aspect, in the second determination mode, the determination circuit may determine the state of the ejection section according to a cycle and an amplitude of the residual vibration detection signal acquired based on the detection voltage signal.

In the head unit according to the aspect, the determination circuit may include a first determination circuit that determines the state of the ejection section in the first determination mode, and a second determination circuit that determines the state of the ejection section in the second determination mode.

What is claimed is:

1. A liquid ejecting apparatus comprising:
a transport section that transports a medium;
an ejection section that ejects liquid to the medium;
a residual vibration detection circuit that acquires a residual vibration signal corresponding to residual vibration generated in the ejection section and outputs a residual vibration detection signal corresponding to the residual vibration signal;
a first conversion circuit that includes a comparison circuit and outputs a comparison result signal in which a logic level changes according to a comparison result between a voltage value of the residual vibration detection signal and a reference voltage value;
a second conversion circuit that includes an A/D conversion circuit and outputs a detection voltage signal obtained by converting the residual vibration detection signal into a digital signal; and
a determination circuit that determines a state of the ejection section, wherein
the determination circuit includes
a first determination mode in which the state of the ejection section is determined according to the comparison result signal, and
a second determination mode in which the state of the ejection section is determined according to the detection voltage signal.

2. The liquid ejecting apparatus according to claim 1, wherein
the determination circuit determines the state of the ejection section in the second determination mode when it is determined that the ejection section has an abnormality in the first determination mode, and
does not execute the determination of the state of the ejection section in the second determination mode when it is determined that the ejection section does not have the abnormality in the first determination mode.

3. The liquid ejecting apparatus according to claim 1, wherein
the ejection section includes
a nozzle that ejects the liquid,
a first pressure chamber that communicates with the nozzle and in which the liquid is stored,
a second pressure chamber that communicates with the nozzle and in which the liquid is stored,
a first detection element that detects residual vibration generated in the first pressure chamber and outputs the residual vibration as a first residual vibration signal, and
a second detection element that detects residual vibration generated in the second pressure chamber and outputs the residual vibration as a second residual vibration signal, and
outputs a composite wave of the first residual vibration signal and the second residual vibration signal as the residual vibration signal.

4. The liquid ejecting apparatus according to claim 1, wherein
in the first determination mode, the determination circuit determines the state of the ejection section based on at least one of a time during which the voltage value of the residual vibration detection signal exceeds the reference voltage value and a time during which the voltage value of the residual vibration detection signal falls below the reference voltage value.

5. The liquid ejecting apparatus according to claim 1, wherein
in the second determination mode, the determination circuit determines the state of the ejection section according to a cycle and an amplitude of the residual vibration detection signal acquired based on the detection voltage signal.

6. The liquid ejecting apparatus according to claim 1, wherein
the determination circuit includes a first determination circuit that determines the state of the ejection section in the first determination mode, and a second determination circuit that determines the state of the ejection section in the second determination mode.

7. A head unit comprising:
an ejection section that ejects liquid to a medium;
a residual vibration detection circuit that acquires a residual vibration signal corresponding to residual vibration generated in the ejection section and outputs a residual vibration detection signal corresponding to the residual vibration signal;
a first conversion circuit that includes a comparison circuit and outputs a comparison result signal in which a logic level changes according to a comparison result between a voltage value of the residual vibration detection signal and a reference voltage value;
a second conversion circuit that includes an A/D conversion circuit and outputs a detection voltage signal obtained by converting the residual vibration detection signal into a digital signal; and
a determination circuit that determines a state of the ejection section, wherein
the determination circuit includes
a first determination mode in which the state of the ejection section is determined according to the comparison result signal, and
a second determination mode in which the state of the ejection section is determined according to the detection voltage signal.

8. The head unit according to claim 7, wherein
the determination circuit determines the state of the ejection section in the second determination mode when it is determined that the ejection section has an abnormality in the first determination mode, and
does not execute the determination of the state of the ejection section in the second determination mode when it is determined that the ejection section does not have the abnormality in the first determination mode.

9. The head unit according to claim 7, wherein
the ejection section includes
a nozzle that ejects the liquid,
a first pressure chamber that communicates with the nozzle and in which the liquid is stored,
a second pressure chamber that communicates with the nozzle and in which the liquid is stored,
a first detection element that detects residual vibration generated in the first pressure chamber and outputs the residual vibration as a first residual vibration signal, and
a second detection element that detects residual vibration generated in the second pressure chamber and outputs the residual vibration as a second residual vibration signal, and
outputs a composite wave of the first residual vibration signal and the second residual vibration signal as the residual vibration signal.

10. The head unit according to claim 7, wherein
in the first determination mode, the determination circuit determines the state of the ejection section based on at least one of a time during which the voltage value of the residual vibration detection signal exceeds the reference voltage value and a time during which the voltage value of the residual vibration detection signal falls below the reference voltage value.

11. The head unit according to claim 7, wherein
in the second determination mode, the determination circuit determines the state of the ejection section according to a cycle and an amplitude of the residual vibration detection signal acquired based on the detection voltage signal.

12. The head unit according to claim 7, wherein
the determination circuit includes a first determination circuit that determines the state of the ejection section in the first determination mode, and a second determination circuit that determines the state of the ejection section in the second determination mode.
